(19) United States
(12) Patent Application Publication
(10) Pub. No.: US 2010/0060959 A1
(43) Pub. Date: Mar. 11, 2010

(54) REPRODUCTION APPARATUS AND REPRODUCTION METHOD

(75) Inventor: Kazutatsu TOKUYAMA, Tokyo (JP)

Correspondence Address: ROBERT J. DEPKE;LEWIS T. STEADMAN, ROCKEY, DEPKE & LYONS, LLC, SUITE 5450 SEARS TOWER, CHICAGO, IL, 60606-6306, US

(73) Assignee: Sony Corporation, Tokyo (JP)

(21) Appl. No.: 12/509,265

(22) Filed: Jul. 24, 2009

(30) Foreign Application Priority Data
Sep. 9, 2008 (JP) 2008-231361

(51) Int. Cl. G03H 1/12

(52) U.S. Cl. 359/11

(57) ABSTRACT

In a reproduction apparatus, a modulation control generates reference light by performing a drive control on respective pixels in reference light areas of a spatial light modulator and a phase modulator and also generates DC light added to a reproduction image by performing a drive control in a signal light area of a spatial light modulator to apply a spatial light intensity modulation at a same modulation amount in all pixels and performing a drive control in a signal light area of the phase modulator while setting one part of phase modulation amounts as a phase modulation amount for setting a same phase as a reference phase in the reproduction image obtained from a hologram recording medium in accordance with irradiation of the reference light and setting the other part of the phase modulation amounts as a phase modulation amount different by π with respect to the one part of the phase modulation amounts.

### BACKGROUND OF THE INVENTION

1. Field of the Invention

The present invention relates to a reproduction apparatus configured to reproduce data recorded on a hologram recording medium by way of interference fringes resulting from a reference light and a signal light and a method therefor.

2. Description of the Related Art

For example, Japanese Unexamined Patent Application Publication Nos. 2006-107663 and 2007-79438 disclose a hologram recording reproduction system in which data is recorded through a formation of a hologram by way of interference fringes resulting from a signal light and a reference light, and the data recorded in the form of the hologram functioning as the interference fringes is reproduced through irradiation of the reference light. This hologram recording reproduction system includes a so-called coaxial system in which the signal light and the reference light are arranged on the same axis for the recording.

FIGS. 14, 15A and 15B are explanatory diagram for describing the hologram recording reproduction system of the coaxial system. FIG. 14 shows a recording system, and FIGS. 15A and 15B show a reproduction system.

First, in FIG. 14, at the time of the recording, an SLM (spatial light modulator) 101 applies a spatial light intensity modulation (which is also referred to as light intensity modulation or simply referred to as intensity modulation) on incident light from a light source so that a signal light and a reference light arranged on the same axis as shown in the drawing are generated. The SLM 101 can be composed, for example, of a liquid crystal panel which is designed to transmit/intercept the incident light in units of pixel or the like.

At this time, the signal light is generated while being provided with a light intensity pattern in accordance with recording data. Also, the reference light is generated while being provided with a predetermined intensity pattern.

The signal light and the reference light thus generated in the SLM 101 enter a phase mask 102. At this time, the phase mask 102 provides the random phase pattern to the signal light and the reference light as shown in the drawing.

Here, the random phase modulation pattern is provided to the signal light and the reference light for improving the interference efficiency of the signal light and the reference light and for diffusing the spectra of the signal light and the reference light so that DC components are suppressed, and a higher recording density is realized.

A specific random phase pattern for realizing the DC component suppression includes, for example, one in which a random phase pattern based on two values of “0” and “π” is set. That is, such a random phase modulation pattern is set that pixels where the phase modulation is not performed (that is, the phase=0) and pixels where the phase is modulated by π (180°) are arranged half each.

Here, depending on the light intensity modulation by the SLM 101, for the signal light, a light whose light intensity is modulated into “0” or “1” in accordance with recording data is generated. By applying the phase modulation based on “0” or “π” on such a signal light, the light having “−1”, “0” or “1 (+1)” for a wave-front amplitude of the light is generated. That is, when the modulation based on the phase “0” is applied to the pixel modulated by the light intensity “1”, the amplitude is “1”, and the modulation based on the phase “π” is obtained, the amplitude is “−1”. It should be noted that for the pixel of the light intensity “0”, the amplitude remains “0” with respect to the any modulation based on the phase “0” or “π”.

For confirmation, FIGS. 16A and 16B show differences of the signal light and the reference light between a case where the phase mask 102 does not exist (FIG. 16A) and a case where the phase mask 102 exists (FIG. 16B. It should be noted that FIGS. 16A and 16B represent a magnitude relation of the light amplitude based on a color density. To be more specific, FIG. 16A represents the amplitude “0”→“1” with black→white and FIG. 16B represents the amplitude “−1”→“0”→“1 (+1)” with black→gray→white.

The phase pattern by the phase mask 102 is a random pattern. With this configuration, the pixels having the light intensity of “1” in the signal light output from the SLM 101 can be divided into pixels having the amplitudes “1” and “−1” randomly (half each). In this manner, as the pixels are randomly divided to have the amplitudes “1” and “−1”, the spectra can be uniformly scattered on the Fourier plane (the frequency plane: which can be considered as an image on media). Thus, the DC component suppression in the signal line can be realized. In addition, with the phase mask 102, the DC component suppression of the reference light can also be realized. As a result, the generation of the DC components on the Fourier plane can be prevented.

In this manner, when the DC component suppression can be realized, the data recording density can be improved.

This is because, in a case where the DC component is generated, a recording material is substantially reacted by the DC component, and it is difficult to perform the hologram multiple recording. That is, with respect to a part where the DC component is recorded, it is difficult to multiply the hologram (data) any more for the recording.

When the DC component suppression can be realized by using the above-mentioned random phase pattern, the data multiple recording can be performed, and the higher recording density is realized.

The description is back to the previous part.

The signal light and the reference light via the phase mask 102 are both collected by an objective lens 103, and a hologram recording medium HM is irradiated with the collected light. With this configuration, in the hologram recording medium HM, interference fringes (diffraction grating: hologram) is formed in accordance with the signal light (recording image). That is, data is recorded on the basis of the formation of the interference fringes.

Subsequently, at the time of the reproduction, first, as shown in FIG. 15A, the reference light is generated through the spatial light modulation (intensity modulation) of the SLM 101 with respect to the incident light. Then, the hologram recording medium HM is irradiated with the thus generated reference light via the phase mask 102→the objective lens 103.

As the hologram recording medium HM is irradiated with the reference light, as shown in FIG. 15B, diffraction light in accordance with the recorded hologram is obtained, and the diffraction light is output from the hologram recording medium HM as a reflection light. That is, the reproduction image (reproduction light) is obtained in accordance with the recording data.

Then, the light of the thus obtained reproduction image is received by an image sensor 104 such as, for example, a (Charge Coupled Device) sensor or a CMOS (Complementary Metal Oxide Semiconductor) sensor, and the reproduction of the recorded data is performed on the basis of the reception light signal of the image sensor 104.

At this time, in the hologram recording reproduction system, by recording the signal light having the intensity information in accordance with the recording data after being applied with the phase modification based on “0” or “π” as described above, the DC component suppression is realized, and the hologram multiple recording can be performed.

In a case where such a phase modulation recording is performed, as shown in FIG. 16B, the signal light includes the three values of “0”, “1”, and “−1” as the amplitude information. That is, these three values are recorded on the hologram recording medium HM.

However, a problem encountered at this time is that the image sensor 104 configured to detect the reproduction image at the time of the reproduction only detects information on the light intensity.

Here, in general, an optical system of the hologram recording reproduction system has a configuration based on a 4f optical system in which the SLM, the objective lens, the media, an eyepiece lens (objective lens), the image sensor are arranged while being respectively separated at a focal distance of the lens, which is a configuration referred to as Fourier transform hologram.

According to the configuration of the Fourier transform hologram, a series of the operations for the recording and the reproduction described above can be regarded as follows. That is, the recording pattern of the SLM is subjected to a Fourier transform to be projected on the hologram recording medium (media), and a read signal (reproduction image) of the media is subjected to a reverse Fourier transform to be projected on the image sensor. Then, the image sensor detects the light intensity in which the absolute value the wave-front amplitude of the incident light is squared.

From this point, in the hologram recording reproduction system in the related art, both the intensity and the phase can be recorded, but only the information on the intensity among those can be reproduced on the reproduction side. Thus, the hologram recording reproduction system in the related art has nonlinearity. In the hologram recording reproduction system in the related art, due to a problem of such nonlinearity, it is extremely difficult to appropriately carry out the data reproduction in a case where the phase modulation recording is performed.

In order to solve the problem of such nonlinearity, the applicant of the present invention has previously proposed a method of realizing “linear reading” with which the phase information recorded on the media (specifically, the information on the amplitude “−1” in this case) is appropriately read. To be more specific, this is the reading method so called “coherent addition system” described in Japanese Unexamined Patent Application Publication No. 2008-152827.

According to the “coherent addition system”, at the time of the reproduction, a coherent light shown in FIG. 17 is generated, and the hologram recording medium HM is irradiated with the coherent light together with the reference light. That is, according to the normal reproduction method described above with reference to FIGS. 15A and 15B, the irradiation of the reference light for obtaining the reproduction image is performed, but according to the coherent addition system, furthermore the irradiation of the coherent light is also performed.

The coherent light refers to a light generated so that the light intensity and the phase are respectively uniform. Also in the coaxial system, the coherent light is generated in such a manner that as also shown in FIG. 17, the light is transmitted in the same area as the area where the signal light is generated at the time of the recording (which is referred to as signal light area).

It should be noted that the coherent light is also referred to as “DC light” in a sense that the light has the uniform intensity.

With reference to FIGS. 18A and 18B, a reproduction system according to the coherent addition system will be specifically described.

First, in a case where a reproduction according to the coherent addition system is performed, it is supposed that a phase modulator (a phase modulator 101b in FIG. 18A) capable of performing a variable phase modulation is provided for a phase modulation element. Here, according to the recording reproduction system in which the reproduction is performed on the basis of the coherent addition system, for a phase pattern provided to the incident light, a phase pattern (a binary random phase pattern corresponding to the phase mask 102) for enabling the above-mentioned multiple recording is set at the time of the recording, and a uniform phase pattern for generating a coherent light which will be described below is set at the time of the reproduction. That is, from the above, for the phase modulation element in this case, the phase modulator 101b capable of performing a variable phase modulation is used.

In this case, an intensity modulator 101a configured to perform an intensity modulation on the incident light and the phase modulator 101b are integrally formed to be constructed as the SLM 101. With the SLM 101, it is possible to arbitrarily modulate the intensity and the phase of the incident light.

As shown in FIG. 18A, the reference light and the coherent light are generated by the SLM 101 at the time of the reproduction in this case.

At the time of the reproduction, first, the reference light is generated so as to have the same intensity pattern and the same phase pattern as those at the time of the recording. That is, the reference light having the same intensity and phase patterns as those at the time of recording the hologram serving as the reproduction target is generated. This is because, in order to appropriately reproduce the multiply recorded hologram, the irradiation of the reference light having the same patterns as those at the time of recording the relevant hologram should be performed. In other words, the hologram recorded through the irradiation of the reference light having certain patterns can be appropriately reproduced only by using the reference light having the patterns.

In this sense, the reference light at the time of the reproduction is generated so as to have the same intensity and phase patterns as those at the time of the recording.

As described above, the coherent light is generated in such a manner that the incident light is transmitted through the area where the signal light is generated at the time of the recording (signal light area). To be more specific, the coherent light has the uniform intensity by modulating the respective pixels in the signal light area to have a predetermined intensity in the intensity modulator 101a.

According to the “coherent addition system”, both the coherent light (DC light) having the uniform intensity and the reproduction image obtained in accordance with the irradiation of the reference light are imaged on the image sensor 104. With this configuration, the image sensor 104 performs detection for a synthesis light of the reproduction image and the coherent light.

At this time, the coherent light is added as the component in the same phase as the reproduction image (in-phase). For this reason, the phase of the coherent light is aligned with the phase of the reproduction image (the reference phase in the reproduction image).

It should be noted that the above-mentioned “reference phase in the reproduction image” refers to a phase of the pixel applied with the modulation of the phase “0” (0π) and recorded among the images (recording signals) of the SLM 101 in units of pixel included in the reproduction image.

At this time, as described above, the reference phase in the reproduction image is a phase of the signal applied with the phase modulation of 0π by the phase modulator 101b and recorded. Therefore, in order to match the phase of the coherent light with this reference phase in the reproduction image, it is conceivable that the coherent light may also be applied with the phase modulation of the phase “0” in the phase modulator 101b.

It should be however noted that according to the hologram recording reproduction system, it is taken into account that the phase of the reproduction image obtained by irradiating the hologram recording medium HM (media) with the reference light is shifted by π/2 from the phase of the signal recorded on the media. That is, if the modulation of the phase “0” is applied on the DC light obtained through the intensity modulation, the reference phase in the reproduction image and the phase of the coherent light have a phase difference of “π/2”, and the coherent light is not appropriately added as the component in the same phase as the reproduction image.

By taking this point into account, in order to match the phase of the coherent light with the reference phase in the reproduction image, in the phase modulator 101b, the modulation of “π/2” is applied as shown in the drawing. To be more specific, the phase modulator 101b in this case is configured to apply the phase modulation of π/2 to the respective pixels in the signal light area.

In accordance with the generation of the reference light and the coherent light through the spatial light modulation in the SLM 101 described above, as shown in FIG. 18B, the reproduction image and the coherent light in the same phase as the reproduction image are guided via the objective lens 103 to the image sensor 104. At this time, the coherent light is detected by the image sensor 104 as being added as the component in the same phase as the reproduction image.

According to the “coherent addition system”, while it is supposed that the component of the “reproduction image+coherent light” is detected by the image sensor 104, the following processing is applied on the image signal of the detected “reproduction image+coherent light” to obtain the linear read signal.

First, as to the image signal of the “reproduction image+coherent light”, a square root of a value of the respective pixels is calculated.

After that, from this square root calculated result, a processing of eliminating the added component of the coherent light is performed. To be more specific, for example, the added value of the intensity of the coherent light is subtracted from a value of the square root calculated result.

Here, realization of the linear reading through the above-mentioned series of operation of the addition of the coherent light, the square root calculation, and the elimination of the addition will be described.

It should be noted that in the following description, the amplitude of the reproduction image is within ±0.078, for example. That is, the amplitude of the reproduction image has the maximum value=0.078 and the minimum value=−0.078.

In addition, the value of the intensity of the coherent light added to the reproduction image is, for example, 0.1.

First, for comparison, a case is discussed in which the read is performed by only using the irradiation of the reference light without performing the coherent addition as in the related art.

On the premises of the Fourier transform hologram and the maximum value and the minimum value of the amplitude of the reproduction image described above, the output value of the image sensor 104 obtained in accordance with the maximum value and the minimum value of the amplitude of the reproduction image in this case is obtained to have its square value “6.1E−3” which is the same value. In this manner, as the image sensor 104 detects the value equivalent to “+1” and “−1” as the same value, the lost phase information is not accurately reconstructed by performing any of signal processings in a later stage. That is, a nonlinear distortion is generated.

On the other hand, according to the “coherent addition system”, in the case of the irradiation of the reference light and the coherent light in the same phase as the reproduction image, the value in accordance with the intensity of the coherent light can be added to the reproduction image. It should be noted that as a description is given for confirmation, the above-mentioned coherent light is the DC component so as to have the uniform amplitude and phase, and therefore the coherent light does not interfere the recorded hologram.

Here, according to the above-mentioned explanation, the addition amount of the coherent light in this case is, for example, 0.1. Thus, the reproduction image is added with this component of 0.1, and the maximum value 0.078 is detected as the intensity of 0.178²=0.032 and the minimum value −0.078 is detected as the intensity of 0.022²=4.8E−4 by the image sensor 104. In this case, with respect to the output of the image sensor 104, the square root is calculated in the above-mentioned manner, and the added component is eliminated thereafter. Therefore, the maximum value of the amplitude 0.078 can be reconstructed to the original value through 0.178−0.1=0.078, and also the minimum value −0.078 can be reconstructed to the original value through 0.022−0.1=−0.078.

In this manner, according to the reproduction method based on the “coherent addition system”, it is possible to realize the linear reading where the phase information recorded through the phase modulation recording is not lost.

It should be noted that what is important here is the addition amount of the coherent light (intensity value) with respect to the reproduction image. That is, for realizing the above-mentioned linear reading, the addition amount of the coherent light at least meets a condition of a “value larger than the absolute value of the minimum value of the amplitude of the reproduction image” so that negative folding is not generated with respect to the intensity detection by the image sensor 104 (squared).

From this point, according to the “coherent addition system”, the coherent light can be defined as having the intensity at the time of being added to the reproduction image as the “value larger than the absolute value of the minimum value of the amplitude of the reproduction image” and also having the phase in the “same phase as the reference phase of the reproduction image”.

### SUMMARY OF THE INVENTION

In the above-mentioned manner, according to the “coherent addition system”, in a case where the three values of the amplitudes “−1”, “0”, and “+1” are recorded for realizing the higher recording density in terms of the DC component suppression by the phase modulation recording, “−1” and “+1” including the phase information together with the amplitude “0” can be appropriately read out, so that it is possible to realize the linear reading.

However, in the coherent addition system in the related art, for the light added to the reproduction image, the coherent light is generated so as to have not only the uniform intensity but also the uniform phase. Thus, as the hologram recording medium is irradiated with the coherent light via the objective lens, the recorded data may be destroyed. To be more specific, the intensity and the phase are set to be uniform in this manner, the intensity concentration at the focal position of the objective lens (the Fourier plane) is promoted, which leads to the destruction of the recorded hologram at the part where the intensity concentrates. Thus, the data destruction is generated.

It should be noted that in order to prevent the data destruction due to the intensity concentration, the applicant of the present invention has previously proposed a method of providing a gap layer between a recording film and a reflection film as a hologram recording medium. That is, by using the hologram recording medium provided with the gap layer as described above, the focal position (that is, the position where the intensity concentration is generated) can be shifted by the thickness of the gap layer from the recording film. As a result, an influence of the intensity concentration on the recording film is suppressed.

However, in a case where the method of providing the gap layer is adopted in this manner, it is difficult to obtain sufficient recording reproduction characteristics in some cases. That is, in this case, as the gap layer mediates, the interference efficiency of the signal light and the reference light at the time of the recording is lowered. As a result, the deterioration of the recording characteristics of the hologram and furthermore the deterioration of the reproduction characteristics may be promoted.

The present invention has been made in view of the above-mentioned problems, and it is desirable to prevent data destruction due to DC light without inserting a gap layer which leads to deterioration of recording reproduction characteristics in a case where a hologram recording medium is irradiated with the DC light set to have the uniform intensity together with the reference light at the time of reproduction, and a linear read signal is obtained by detecting a component in which the DC light via a hologram recording medium is added to a reproduction image obtained in accordance with irradiation of the reference light.

In order to achieve the above, a reproduction apparatus according to an embodiment of the present invention has the following configuration.

That is, according to an embodiment of the present invention, there is provided a reproduction apparatus including a light source configured to perform a light irradiation on a hologram recording medium on which data is recorded by way of interference fringes resulting from a signal light and a reference light; an intensity modulation unit provided with a spatial light modulator arranged to apply a spatial light modulation on an incident light in units of pixel while setting a signal light area serving as a generation area for the signal light and a reference light area serving as a generation area for the reference light and configured to perform a spatial light intensity modulation on the incident light; a phase modulator configured to apply a spatial light phase modulation on the incident light in units of pixel while setting the signal light area and the reference light area; an optical system configured to guide a light emitted from the light source to the hologram recording medium via the intensity modulation unit, the phase modulator, and an objective lens; and a modulation control unit configured to generate the reference light by performing a drive control on respective pixels in the reference light areas of the spatial light modulator and the phase modulator and also generate a DC light to be added to a reproduction image by performing a drive control in the signal light area of the spatial light modulator to apply a spatial light intensity modulation at a same modulation amount in all pixels and performing a drive control in the signal light area of the phase modulator while setting one part of phase modulation amounts as a phase modulation amount for setting a same phase as a reference phase in the reproduction image obtained from the hologram recording medium in accordance with an irradiation of the reference light and setting the other part of the phase modulation amounts as a phase modulation amount different by π with respect to the one part of the phase modulation amounts.

In the above-mentioned manner, according to the embodiment of the present invention, as to the DC light having the uniform intensity whose irradiation is performed together with the reference light at the time of the reproduction, instead of applying the uniform phase modulation across the entire area, the phase modulation for setting the same phase as the reference phase of the reproduction image is applied on a part, and the phase modulation at the phase modulation amount different by π from that of the part is applied on the other part.

In this manner, by applying the phase modulations at the different phase modulation amounts in a divided manner with respect to the DC light, it is possible to provide a nonuniformity to the amplitude distribution of the wave front of the DC light. As a result, it is possible to prevent the intensity concentration of the DC light on the Fourier plane functioning as the focal position of the objective lens.

According to the embodiment of the present invention, by applying the divisive phase modulations while partially varying the phases of the DC light instead of using the uniform phase, it is possible to prevent the intensity concentration of the DC light on the Fourier plane. As a result, it is possible to prevent the data destruction which may be generated in the case of the irradiation of the DC light (coherent light) having the uniform phase as in the related art.

In addition, in the above-mentioned manner, according to the embodiment of the present invention, as the intensity concentration of the DC light on the Fourier plane is prevented, the deterioration of the recording reproduction characteristics as in the case of adopting the method of providing the gap layer between the recording film and the reflection film of the hologram recording medium previously proposed by the applicant of the present invention may not be caused.

### BRIEF DESCRIPTION OF THE DRAWINGS

FIG. 1 is a block diagram of an internal configuration of a recording reproduction apparatus according to an embodiment of the present invention;

FIGS. 2A and 2B are explanatory diagrams for describing an intensity modulation method based on a combination of a polarization direction control type spatial light modulator and a polarization beam splitter;

FIG. 3 is an explanatory diagram for describing respective areas set in the spatial light modulator including a reference light area, a signal light area, and a gap area;

FIGS. 4A and 4B are explanatory diagrams for describing a configuration of a phase modulator capable of performing a spatial light phase modulation in units of pixel;

FIG. 5 is an explanatory diagram for describing an internal configuration of a modulation control unit;

FIG. 6 is an explanatory diagram for describing an example of a phase modulation of a DC light according to an embodiment of the present invention;

FIGS. 7A to 7C are diagrams for verifying an effect in a case where an in-phase component and a reversed-phase component are added to a reproduction image;

FIG. 8 is an explanatory diagram for describing an internal configuration of a data reproduction unit;

FIGS. 9A and 9B show simulation results as to a method of providing a uniform phase to the DC light in a related art;

FIGS. 10A and 10B show simulation results in a case where a division phase modulation (segment size 64×64) is performed according to an embodiment of the present invention;

FIGS. 11A and 11B show simulation results in a case where a division phase modulation (segment size 48×48) is performed according to an embodiment of the present invention;

FIG. 12 is an explanatory diagram for describing a modified example of the segment size;

FIG. 13 is an explanatory diagram for describing a modified example in which a shape of the signal light area is set as rectangular;

FIG. 14 is an explanatory diagram for describing a hologram recording reproduction system (upon recording) based on a coaxial system;

FIGS. 15A and 15B are explanatory diagrams for describing the hologram recording reproduction system (upon reproduction) based on the coaxial system;

FIGS. 16A and 16B are diagram in which the amplitudes of the signal light and the reference light are compared between the presence of a phase mask and the absence of the phase mask;

FIG. 17 is an explanatory diagram for describing a coherent light; and

FIGS. 18A and 18B are explanatory diagrams for describing a coherent addition system.

### DESCRIPTION OF THE PREFERRED EMBODIMENTS

Hereinafter, best modes for implementing the present invention (hereinafter, referred to as embodiments) will be described.

It should be noted that the description tracks the following order.
1. Configuration of a recording reproduction apparatus

Overall configuration

Phase modulation recording
2. Reproduction method based on DC light addition system according to an embodiment

Operation outline

Configuration for realizing the reproduction method according to the embodiment

Simulation result

Effects of the embodiment
3. Modified example

### 1. Configuration of a Recording Reproduction Apparatus

Overall Configuration

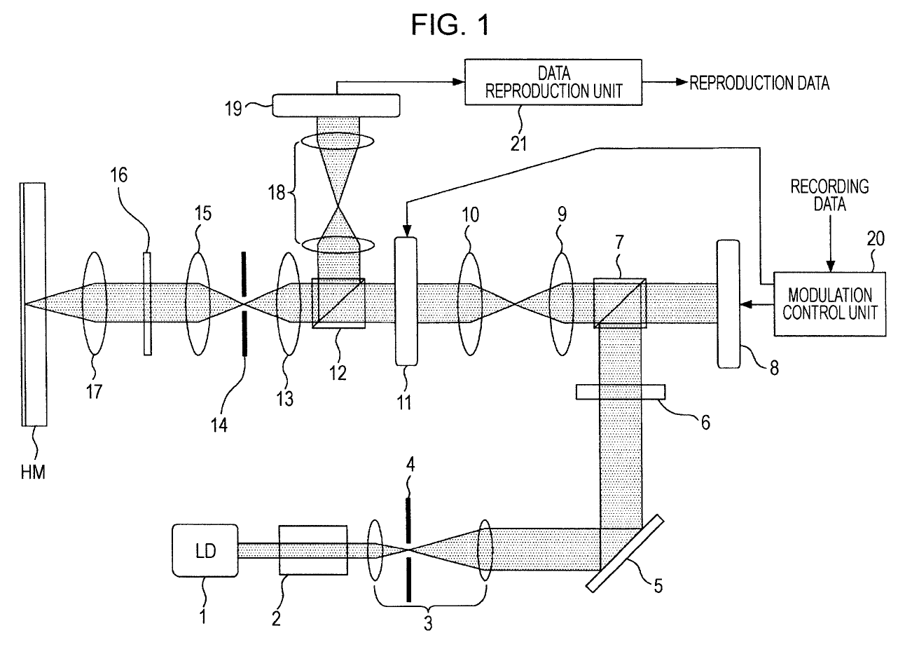

FIG. 1 is a block diagram of an internal configuration of a recording reproduction apparatus according to an embodiment of the present invention.

Herein, a case is exemplified in which the reproduction apparatus according to the embodiment of the present invention is configured as a recording reproduction apparatus which also has a recording function.

The recording reproduction apparatus shown in FIG. 1 is constructed to carry out hologram recording reproduction of a coaxial system. According to the coaxial system, the signal light and the reference light are arranged on the same optical axis, and a hologram recording medium set at a predetermined position is irradiated with the signal light and the reference light to perform data recording by way of a formation of a hologram. Then, at the time of the reproduction, the hologram recording medium is irradiated with the reference light to perform the reproduction of the recorded data in the form of the hologram.

At the time of the recording, the recording reproduction apparatus according to the present embodiment performs the phase modulation recording for the improvement in the recording density. At the time of the reproduction, for realizing the linear reading, the recording reproduction apparatus adopts a reproduction method of performing irradiation of the reference light and the DC light (uniform intensity) like the “coherent addition system” in the related art.

Also, the recording reproduction apparatus according to the present embodiment adopts a configuration that the hologram recording medium HM in the drawing corresponds to a reflective type hologram recording medium provided with a reflection film.

In FIG. 1, a laser diode (LD) 1 is provided as a light source for obtaining a laser light used for the recording reproduction. For the laser diode 1, for example, a laser diode provided with an external resonator is adopted, and the wavelength of the laser light is set, for example, as about 410 nm.

The outgoing light from the laser diode 1 is guided via an isolator 2 to a beam expander 3. Herein, the isolator 2 is configured in such a manner that the reflection light from the optical system (in particular, the reflection light from a polarization beam splitter 7) which will be described below is not returned to the laser diode 1 functioning as the light source.

The beam expander 3 is provided to expand a beam diameter of the incident light to an optimal diameter and configured by at least including two types of lenses and a drive unit configured to drive the lenses in an optical axis direction (not shown in the drawing).

As shown in the drawing, a pin hole (spatial filter) 4 is inserted at the lens focal position of the beam expander 3, and the intensity distribution of the beam is smoothed by the pin hole 4.

The outgoing light from the beam expander 3 is reflected so that the optical axis is bent by a mirror 5 by 45° and thereafter enters the polarization beam splitter 7 via a ½ wavelength plate 6. As to the laser light incident on the polarization beam splitter 7, in accordance with the characteristic of the polarization beam splitter 7, s-polarized light and p-polarized light are transmitted through or are reflected by the polarization beam splitter 7.

In this case, the polarization beam splitter 7 is configured that the s-polarized light is reflected and the p-polarized light is transmitted.

Herein, as shown in the drawing, according to the optical system in this case, after the reflection light of the polarization beam splitter 7 is guided to a reflective type SLM (spatial light modulator) 8 side, the reflection light of the SLM 8 enters the polarization beam splitter 7 again. Then, the re-entered light transmits through the polarization beam splitter 7 and is eventually guided to the objective lens 17.

According to the characteristic of the polarization beam splitter 7, the incident light from the polarization beam splitter 7 to the SLM 8 is the s-polarized light.

At this time, the light from the laser diode 1 functioning as the light source enters the polarization beam splitter 7 via the ½ wavelength plate 6. However, depending on an in-plane rotation angle (that is, an angle defined by the polarization direction axis of the incident linearly-polarized light and the optical reference axis of the ½ wavelength plate 6), the amplitudes of the s-polarized light and the p-polarized light of the incident light on the polarization beam splitter 7 are changed. Thus, the amount of incident light on the SLM 8 is changed. That is, according to the optical system shown in this drawing, by adjusting the above-mentioned in-plane rotation angle of ½ wavelength plate 6, it is possible to adjust the amount of light with which the hologram recording medium HM is eventually irradiated via an objective lens 17.

The SLM 8 includes a reflective type liquid crustal element functioning as an FLC (Ferroelectric Liquid Crystal) and is configured to control the polarization direction in units of pixel as to the incident light.

In accordance with the drive signal from a modulation control unit 20 in the drawing, the SLM 8 performs the spatial light modulation to change the polarization direction of the incident light by 90° for the respective pixels or keep the polarization direction of the incident light unchanged. To be more specific, a polarization direction control is performed so that the pixel whose drive signal is ON is subjected to the angular change of the polarization direction=90° and the pixel whose drive signal is OFF is subjected to the angular change of the polarization direction=0° in units of pixel in accordance with the drive signal.

Herein, with the combination of the polarization direction control type spatial light modulator functioning as the SLM 8 and the polarization beam splitter 7, the intensity modulation unit is formed which is configured to perform the spatial light intensity modulation in units of pixel (which is also referred to as light intensity modulation or simply as intensity modulation) in the recording reproduction apparatus shown in FIG. 1.

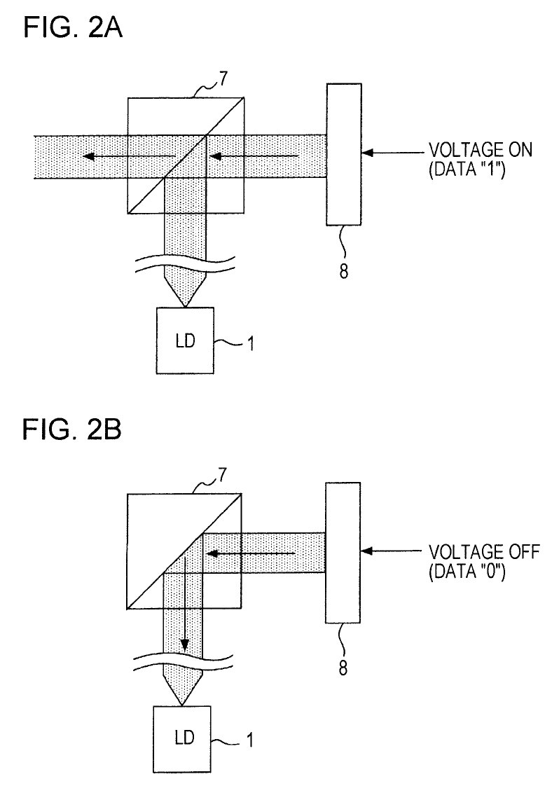

FIGS. 2A and 2B show an image of an intensity modulation operation realized by the combination of the SLM 8 and the polarization beam splitter 7. FIG. 2A schematically shows a light beam state of the light of the ON pixel, and FIG. 2B schematically shows a light beam state of the light of the OFF pixel.

As described above too, the polarization beam splitter 7 in this case reflects the s-polarized light and transmits the p-polarized light, and the s-polarized light enters the SLM 8.

From this point, as to the light of the pixel (the light of the pixel whose drive signal is ON) whose the polarization direction is changed by 90° by the SLM 8, the p-polarized light enters the polarization beam splitter 7. As a result, the light of the ON pixel in the SLM 8 transmits through the polarization beam splitter 7 and is guided to the hologram recording medium HM (FIG. 2A).

On the other hand, as to the light of the pixel in which the drive signal is OFF and the polarization direction is not changed, the s-polarized light enters the polarization beam splitter 7. That is, the light of the OFF pixel in the SLM 8 is reflected by the polarization beam splitter 7 and is not guided to the hologram recording medium HM (FIG. 2B). It should be noted that as a description is given for confirmation, the light reflected by the polarization beam splitter 7 in this way is terminated at the isolator 2 shown in FIG. 1.

Thus, with the combination of the SLM 8 functioning as the polarization direction control type spatial light modulator and the polarization beam splitter 7, it is possible to perform the light intensity modulation in units of pixel.

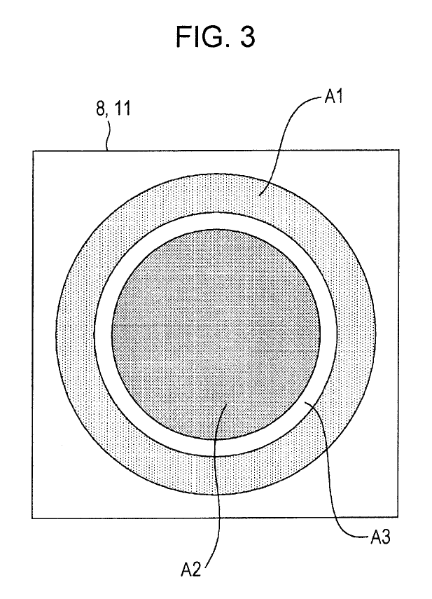

Herein, according to the present embodiment, the coaxial system is adopted for the hologram recording reproduction system. In a case where the coaxial system is adopted, in the SLM 8, in order to arrange the signal light and the reference light on the same optical axis, respective areas shown in FIG. 3 are set.

As shown in FIG. 3, in the SLM 8, a circular area within a predetermined range including the center (optical axis center) is set as a signal light area A2. Then, a circular reference light area A1 is set on an outer side of the signal light area A2 with the intermediation of a gap area A3.

With the setting of the signal light area A2 and the reference light area A1, the irradiation of the signal light and the reference light can be performed so that the signal light and the reference light are arranged on the same optical axis.

It should be noted that the gap area A3 is defined as an area to avoid a situation that the reference light generated in the reference light area A1 leaks into the signal light area A2 to become noise with respect to the signal light.

Also, as a description is given for confirmation, to be more precise, the shape of the respective pixel becomes rectangular in the spatial light modulator. Thus, the shape of the signal light area A2 is substantially circular, and the shape of the reference light area A1 is substantially annular.

The description is back to FIG. 1. The modulation control unit 20 performs the drive control on the SLM 8 and also the drive control on a phase modulator 11 which will be described below. At the time of the recording, for example, the signal light and the reference light to which the binary random phase pattern (the numbers of the phase “0” and the phase “π” are about half each) for the phase modulation recording is provided is generated. Also, at the time of the reproduction, the reference light having the same intensity and phase patterns as those at the time of the recording and the DC light (which will be described below) are generated.

It should be noted that a specific operation content of the modulation control unit 20 will be described below.

The light via the SLM 8 further transmitted through the polarization beam splitter 7 is guided, as shown in the drawing, to a relay lens system based on a relay lens 9→a relay lens 10. The focal position in the relay lens system (the focal position of the relay lens 9) becomes the frequency plane (the Fourier plane).

The laser light via the relay lens system is guided to the phase modulator 11. The phase modulator 11 is configured to apply a spatial light phase modulation (also simply referred to as phase modulation) on the incident light in units of pixel, and the reference light area A1, the signal light area A2, and the gap area A3 are set similarly as in the SLM 8.

In order that a pixel matching with the SLM 8 (a state in which the respective pixels of the SLM 8 and the respective pixels of the phase modulator 11 correspond to one to one) is realized, the insertion position of the phase modulator 11 is at a position functioning as a real image plane of the SLM 8 formed by the relay lens system, and also the position of the phase modulator 11 on the plane parallel to the incident plane is adjusted so that a state is obtained in which the light via the reference light area A1, the signal light area A2, and the gap area A3 of the SLM 8 respectively enter the reference light area A1, the signal light area A2, and the gap area A3 of the phase modulator 11.

Herein, in the case according to the present embodiment, the transmissive type liquid crystal panel capable of performing the phase modulation variable in units of pixel is used for the phase modulator 11.

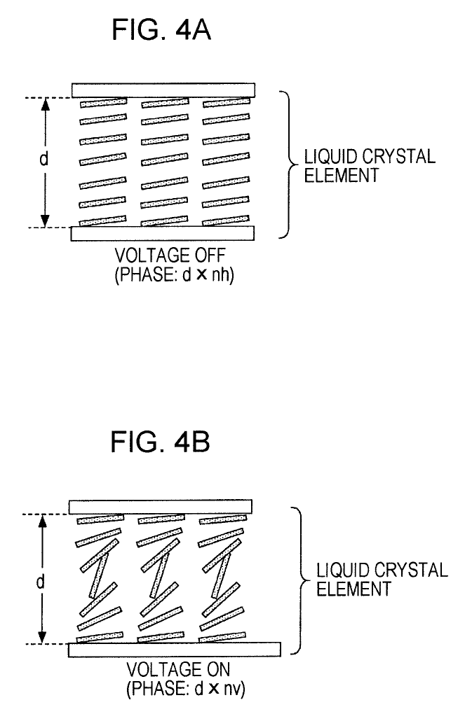

In this manner, the liquid crystal panel capable of performing the phase modulation variable in units of pixel can be realized by configuring the internal liquid crystal element on the basis of the following concepts shown in FIGS. 4A and 4B.

FIG. 4A shows a state of liquid crystal molecules in which the liquid crystal element in the liquid crystal panel is not applied with the drive voltage (that is, the drive voltage OFF state), and FIG. 4B shows a state of the liquid crystal molecules in which the liquid crystal element is applied with the drive voltage at a predetermined level (the drive voltage ON state).

As shown in the drawings, in the drive voltage OFF state shown in FIG. 4A, the liquid crystal molecules has a horizontal orientation, and in the drive voltage ON state shown in FIG. 4B, the liquid crystal molecules is changed to have a vertical orientation.

At this time, as to a refractive index n of the liquid crystal element, when a refractive index at the time of the horizontal orientation due to the drive voltage OFF is set as nh, and a refractive index at the time of the vertical orientation due to the predetermined drive voltage ON is set as nv, in a case where a thickness of the liquid crystal element is set as d, the phase change amount provided at the time of the drive voltage OFF is “d×nh”, and the phase change amount provided at the time of the drive voltage ON is “d×nv”. Therefore, from this point, a phase difference And which can be provided due to ON/OFF of the drive voltage is represented as follows.

Δnd=d×nh−d×nv

From this relational expression, for providing a predetermined phase difference in units of pixel, a thickness d of the liquid crystal element may be adjusted.

For the phase modulator 11 according to the present embodiment, by adjusting the thickness d of the liquid crystal element, for example, a setting is made so that the phase difference Δnd=2π is established. That is, thus, for the respective pixels, by performing the switching of the drive voltage between ON/OFF, it is possible to apply the light phase modulation based on two values of “0” and “2π”.

Also, as described above, as the modulation based on the phases “0” and “2π” can be performed at the time of the drive voltage ON at the predetermined level and at the time of the drive voltage OFF, by controlling the drive voltage level stepwise to the predetermined level, the phases can be changed stepwise from “0” to “2π”. For example, when the drive voltage level is set as ½ of the predetermined level, the modulation based on the phase “π” can be performed, and also when the drive voltage level is set as ¼ of the predetermined level, the modulation based on the phase “π/2” can be performed.

The description is back to FIG. 1.

The light via the phase modulator 11 is guided to a polarization beam splitter 12. The polarization beam splitter 12 is configured to transmit the p-polarized light and reflect the s-polarized light. Therefore, the laser light guided via the phase modulator 11 (the p-polarized light) transmits through the polarization beam splitter 12.

The laser light transmitting through the polarization beam splitter 12 is guided to a relay lens system of a relay lens 13→a relay lens 15. As shown in the drawing, according to the relay lens system, an aperture 14 is arranged at the focal position (the Fourier plane) of the relay lens 13. The aperture 14 is configured to transmit only the light within a predetermined range about the optical axis and interrupt other lights. With the aperture 14, the size of a hologram page recorded on the hologram recording medium HM is limited, and the recording density of the hologram (that is, the data recording density) is improved.

The light via the relay lens 13→the aperture 14→the relay lens 15 enters a polarizing diffraction element 16. The polarizing diffraction element 16 is composed of a combination of a partial diffraction element having a liquid crystal diffraction element formed in an area where the reference light enters and a ¼ wavelength plate. The liquid crystal diffraction element in the partial diffraction element is configured to transmit the p-polarized light and diffract the s-polarized light. Therefore, the incident light from the relay lens system (the p-polarized light) transmits through the partial diffraction element. Then, the p-polarized light transmitting through the partial diffraction element in this manner is transformed into a circularly-polarized light by transmitting through the ¼ wavelength plate.

The hologram recording medium HM is irradiated with the light transformed into the circularly-polarized light via the polarizing diffraction element 16, via the objective lens 17.

Herein, as will be also described below, at the time of the recording, the spatial light modulation by way of the intensity modulation unit based on the combination of the SLM 8 and the polarization beam splitter 7 and the phase modulator 11 is performed, the signal light and the reference light are generated. Therefore, at the time of the recording, the hologram recording medium HM is irradiated with the signal light and the reference light via the above-described optical paths, and as a result, interference fringes (diffraction grating: hologram) resulting from the signal light and the reference light are formed on the hologram recording medium HM. That is, with this configuration, the data recording is carried out.

Also, at the time of the reproduction, the spatial light modulation by way of the intensity modulation unit based on the combination of the SLM 8 and the polarization beam splitter 7 and the phase modulator 11 is performed, the reference light and the DC light are generated. As the hologram recording medium HM is irradiated with the reference light via the above-described optical path, a diffraction light in accordance with the hologram formed on the hologram recording medium HM is obtained as a reproduction light (reproduction image). This reproduction light is returned to the recording reproduction apparatus side as the reflection light from the hologram recording medium HM.

Also, the DC light is reflected by the hologram recording medium HM to be returned to the recording reproduction apparatus side.

Also, the reference light emitted to the hologram recording medium HM is also returned to the apparatus side as the reflection light from the hologram recording medium HM.

Herein, in the hologram recording reproduction system, with the irradiation of the reference light in the above-mentioned manner, the reproduction image is obtained by utilizing a diffraction phenomenon in accordance with the recorded hologram. The diffraction efficiency at this time is generally several % to lower than 1%. Therefore, the reference light thus returned to the apparatus side as the reflection light has an extremely large intensity with respect to the reproduction image. For this reason, the reference light serving as the reflection light becomes a noise component non-negligible upon the detection of the reproduction image.

In the recording reproduction apparatus shown in FIG. 1, the reference light serving as the reflection light is suppressed by the polarizing diffraction element 16.

In the above-mentioned manner, the reproduction light obtained as the reflection light from the hologram recording medium HM, the DC light, and the reference light respectively enter the polarizing diffraction element 16 after passing through the objective lens 17.

The respective lights are transformed into the circularly-polarized lights→the s-polarized lights by the ¼ wavelength plate in the polarizing diffraction element 16. Then, the respective lights transformed into the s-polarized lights enter the above-mentioned partial diffraction element in the polarizing diffraction element 16. In this partial diffraction element, as the liquid crystal diffraction elements (diffracting the s-polarized light) are selectively formed in the incident area of the reference light, the reproduction light obtained in the light beam area of the signal light and the DC light transmit through the partial diffraction element and only the reference light is diffracted, that is, suppressed by the partial diffraction element.

The reproduction light and the DC light transformed into the s-polarized light by the polarizing diffraction element 16 passes through the relay lens 15→the aperture 14→the relay lens 13 and reflected by the polarization beam splitter 12 to be guided to an image sensor 19 via a beam expander 18 as shown in the drawing.

The beam expander 18 is provided so as to expand beam diameters of the reproduction light and the DC light.

The image sensor 19 is provided, for example, with an image pickup element such as a CCD (Charge Coupled Device) sensor or a CMOS (Complementary Metal Oxide Semiconductor) sensor and configured to receive the reproduction light (the reproduction image) serving as the reflection light from the hologram recording medium HM guided in the above-mentioned manner and the DC light to be transformed into electric signals. Thus, at the time of the reproduction, a reception light signal (image signal) representing the light intensity detection result in which the DC light is added to the reproduction image is obtained.

The image signal obtained from the image sensor 19 (the reproduction image+the DC light) is supplied to a data reproduction unit 21.

The data reproduction unit 21 performs a predetermined reproduction signal processing and a decode processing on the image signal to perform the reproduction of the recording data. It should be noted that an internal configuration and an operation of the data reproduction unit 21 will be described below.

Phase Modulation Recording

Herein, the recording reproduction apparatus shown in FIG. 1 is provided with the aperture 14, and the higher recording density is realized along with the reduction in the occupying area of the hologram page on the media.

It should be noted that as a description is given for confirmation, the hologram page is synonymous with the interference fringes formed with the one irradiation of the signal light and the reference light. In other words, this hologram page can also be defined as a minimum unit of data that can be recorded on the hologram recording medium HM.

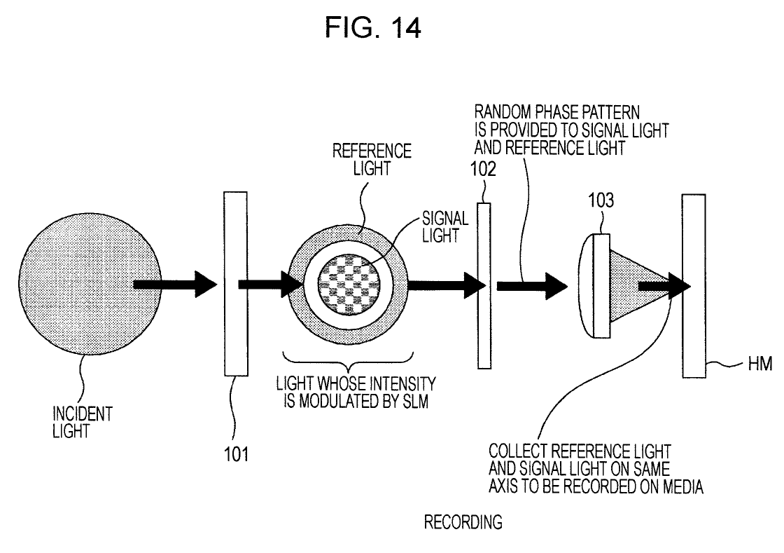

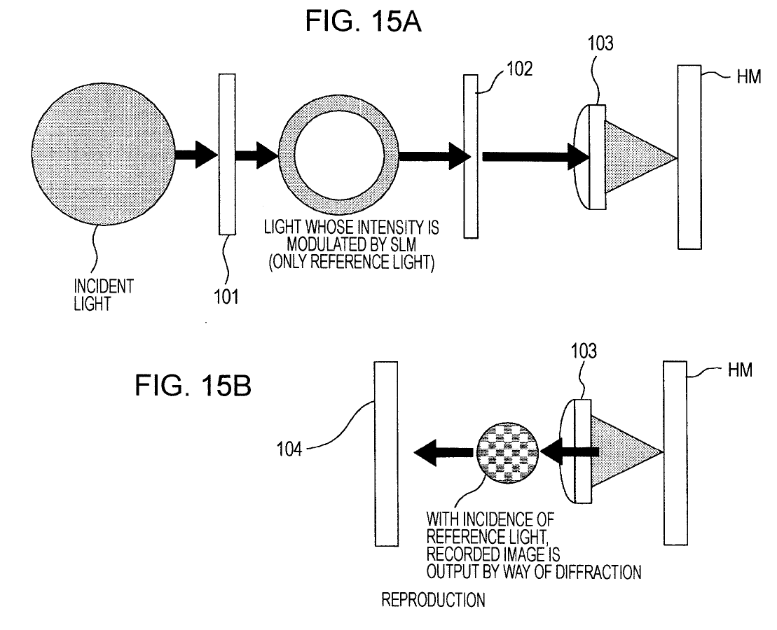

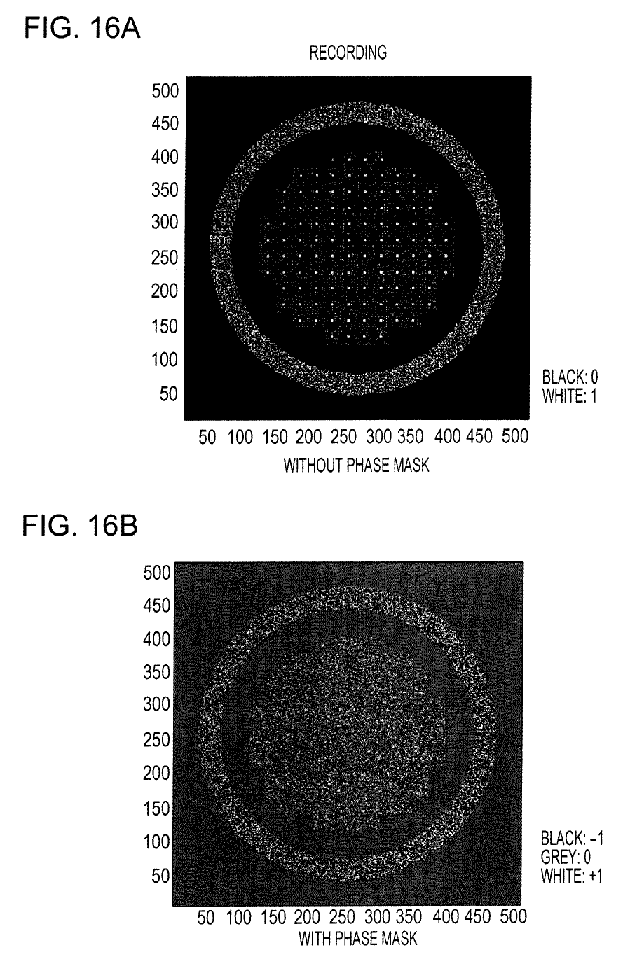

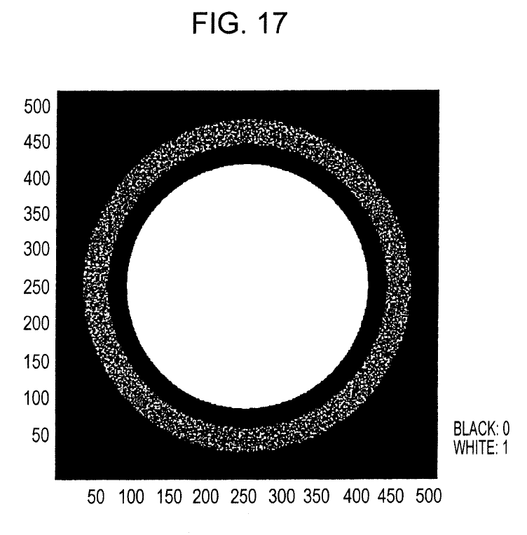

In the recording reproduction apparatus according to the present embodiment, together with the realization of the higher recording density in terms of the reduction in the occupying area of the hologram page by the aperture, furthermore, the recording is performed through the irradiation of the signal light and the reference light providing the phase modulation based on “0” and “π” (for example, the binary random phase pattern) described above with reference to FIGS. 14, 16A, and 16B, the improvement in the recording density is also realized through the DC component suppression. This is what it calls the improvement in the recording density through the phase modulation recording.

In FIG. 1, the above-mentioned phase modulation recording is realized as the modulation control unit 20 performs the drive control on the SLM 8 and the phase modulator 11.

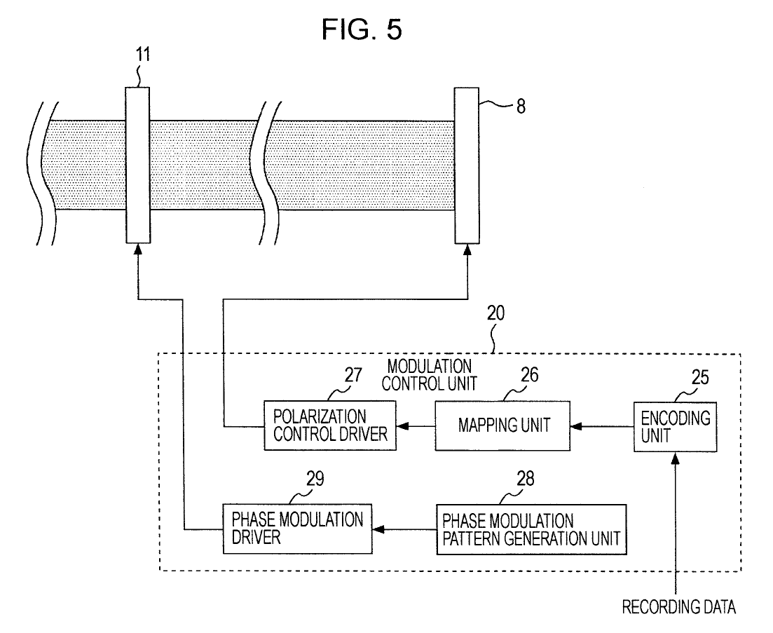

FIG. 5 extracts the SLM 8, the phase modulator 11, and the modulation control unit 20 shown in FIG. 1 and further shows an internal configuration of the modulation control unit 20. It should be noted that FIG. 5 also shows incident/outgoing light of the SLM 8 and incident/outgoing light of the phase modulator 11.

In FIG. 5, in the modulation control unit 20, an encoding unit 25, a mapping unit 26, a polarization control driver 27, a phase modulation pattern generation unit 28, and a phase modulation driver 29 are provided.

First, at the time of the recording, the recording data also shown in FIG. 1 is input to the encoding unit 25. The encoding unit 25 applies a predetermined recording modulation encoding processing on the thus input recording data while following a recording format.

The mapping unit 26 arranges the data encoded by the encoding unit 25 into the signal light area A2 while following the recording format at the time of the recording. That is, through the mapping processing on the data into the above-mentioned signal light area A2, a data pattern for the one hologram page is generated.

Also, together with the data mapping into the above-mentioned signal light area A2, the mapping unit 26 generates a data pattern while setting predetermined pixels in the reference light area A1 as “1”, other pixels as “0” and also setting outer circumferential parts of the gap area A3 and the reference light area A1 as all “0”. Then, the mapping unit 26 combines this data pattern and the data pattern in the signal light area A2 to generate a data pattern for all the effective pixels of the SLM 8.

The thus generated data pattern for all the effective pixels of the SLM 8 is supplied to the polarization control driver 27, and the polarization control driver 27 performs the drive control on the respective pixels of the SLM 8 on the basis of the data pattern.

With this configuration, for the outgoing light from the polarization beam splitter 7 shown in FIG. 1 to the objective lens 17 side, at the time of the recording, a light which becomes the origin of the signal light on which the intensity modulation is applied at the pattern in accordance with the recording data and furthermore a light which becomes the origin of the reference light on which the intensity modulation is applied at a predetermined pattern.

Also, at the time of the recording, in the modulation control unit 20, not only the operation for the drive control on the above-mentioned SLM 8 (that is, the operation for the intensity modulation) but also the operation for the drive control on the phase modulator 11 are performed.

First, the phase modulation pattern generation unit 28 generates the phase modulation pattern that should be set in the signal light area A2 of the phase modulator 11 on the basis of a predetermined data pattern. In the case according to the present embodiment too, for the phase modulation pattern provided upon the phase modulation recording, the binary random phase pattern is set.

Also, together with this, the phase modulation pattern generation unit 28 generates a predetermined phase modulation pattern for the phase modulation pattern that should be set in the reference light area A1 of the phase modulator 11. For the phase modulation pattern set in the reference light area A1 too, the binary random phase pattern is used.

Then, the phase modulation pattern generation unit 28 combines the thus generated respective phase modulation patterns (control patterns for the corresponding respective pixels) for the signal light area A2 and the reference light area A1 to generate the phase modulation pattern for all the effective pixels of the phase modulator 11. At this time, for the pixels other than those in the signal light area A2 and the reference light area A1, for example, the value corresponding to the phase “0” is set.

Then, the thus generated phase modulation pattern is provided to the phase modulation driver 29.

On the basis of the phase modulation pattern supplied from the phase modulation pattern generation unit 28, the phase modulation driver 29 performs the drive control on the respective pixels of the phase modulator 11. Thus, from the phase modulator 11, the signal light and the reference light on which the phase modulation based on the binary random phase pattern is applied are output.

### 2. Reproduction Method Based on DC Light Addition System According to an Embodiment

Herein, as also described above, the hologram recording reproduction system in which the irradiation of only the reference light is performed at the time of the reproduction has the nonlinearity in a sense that the image sensor which detects the image signal of the reproduction image does not detect the phase information additionally.

Then, from such a nonlinearity problem, according to the system in which the irradiation of only the reference light is performed at the time of the reproduction, it is extremely difficult to appropriately perform the data reproduction.

While taking this point into account, the recording reproduction apparatus according to the present embodiment performs the irradiation of the reference light as well as the DC light at the time of the reproduction to carry out the linear reading.

It should be however noted that like the linear reading method based on the so-called “coherent addition system” described as the technology in the related art, in a case where a light (coherent light) having not only the uniform intensity but also the uniform phase over the entire area is generated for the DC light emitted together with the reference light, the intensity concentration of the DC light on the Fourier plane (recording plane) is generated, which may lead to the data destruction.

In view of the above, according to the present embodiment, a divisive phase modulation is applied on the DC light emitted together with the reference light at the time of the reproduction, that is, the phase modulation is partially applied at the different phase modulation amounts, and thus the intensity concentration on the Fourier plane is prevented.

Operation Outline

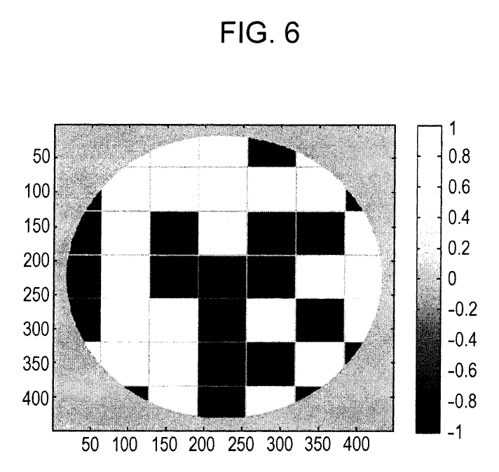

FIG. 6 is an explanatory diagram for describing an example of the phase modulation of the DC light according to the embodiment, in which the amplitude distribution of the DC light emitted from the phase modulator 11 is represented by the color density. Black represents the amplitude “−1”, white represents the amplitude “1”, and gray which is in between white and black represents the amplitude “0”. It should be noted that the amplitude here is an arbitrary unit.

It should be noted that in this drawing, the vertical axis and the horizontal axis denote the number of pixels of the phase modulator 11, and a relation between the DC light (the signal light area A2) and the number of pixels of the phase modulator 11 is also shown.

As shown in FIG. 6, according to the present embodiment, the signal light area A2 for generating the DC light is divided into areas in a lattice pattern, and the respective areas are set as the minimum modulation unit for the phase modulation to carry out the phase modulation. Herein, the respective areas formed through the area division in this manner are referred to as phase modulation segment.

It should be noted that as a description is given for confirmation, the respective phase modulation segments are set through the division in a lattice pattern, and the shapes are square and the sizes are equal to one another.

It should be however noted that as the shape of the signal light area A2 is set to be circular in this case, and a segment shape in the outer circumference part in the signal light area A2 is not square, and the segment size of this part naturally smaller.

In the case according to the present embodiment, the division in a lattice pattern is performed so that the respective areas (the respective grids) have the size of 64×64 pixels.

Then, according to the present embodiment, the phase modulation segment is set as the minimum modulation unit, and the phase modulation based on the different phase modulation amounts is applied in a divided manner.

To be more specific, the phase modulation amounts in units of segment in a divided manner are two types including the phase modulation amount for setting in-phase to the reference phase in the reproduction image and the different phase modulation amount by π with respect to the phase modulation amount so that the linear reading based on the addition of the DC light is appropriately carried out.

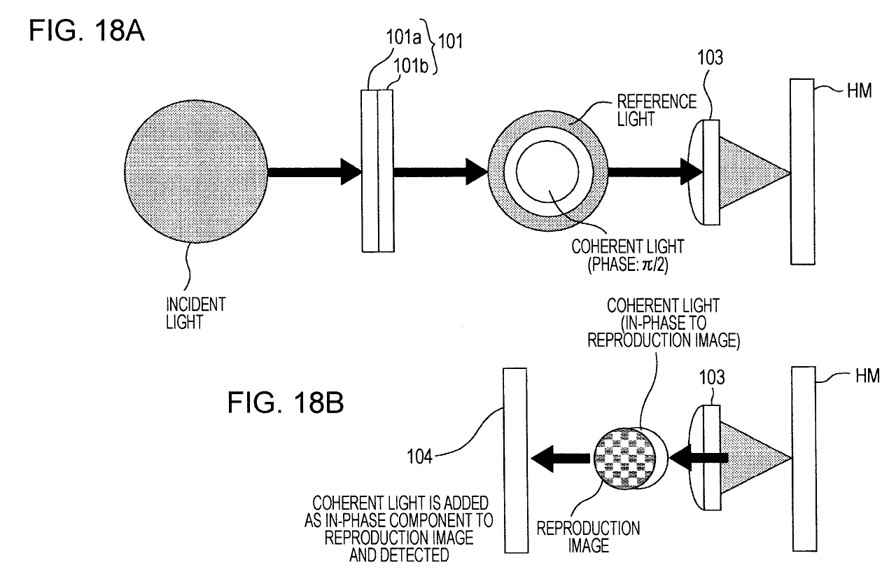

Herein, as will be understood from the above-mentioned description of FIGS. 18A and 18B, in order that the DC light is added as the component in-phase to the reproduction image, the phase modulator 11 may perform the phase modulation based on π/2 on the DC light. That is, as in the case of the present example, in a case where it is supposed that at the time of the recording, the phase modulation based on “0” or “π” is applied on the signal light and the reference light to carry out the phase modulation recording, the reference phase in the recording image (phase of the image recorded by receiving the light of the modulation of the phase “0”) can be set as “0”. Then, in the hologram recording reproduction system, the phase of the reproduction image obtained through the irradiation of the reference light at the time of the reproduction is shifted from the phase of the recording image by π/2 (this point is also described in Kogelnik, H “Coupled wave theory for thick hologramgrating”. Bell System Technical Journal, 48, 2909-47). Therefore, the phase of the reproduction image is provided with a phase difference of π/2 with respect to the phase of the recording image. For this reason, the reference phase in the reproduction image is equivalent to “π/2”.

When the DC light is added as the in-phase component to the reproduction image, the phase of the DC light added to the reproduction image may be in-phase to the reference phase in the reproduction image. From this point, the phase modulation amount that should be provided to the DC light may be set as “π/2” so as to balance out the phase difference of π/2 that is provided to the reproduction image as described above. That is, in order that the light in-phase to the reference phase in the reproduction image is added, the phase modulation amount that should be provided by the phase modulator 11 to the DC light is “π/2”.

From this point, to be more specific, the phase modulation amount provided by the phase modulator 11 in the phase modulation segment unit for setting in-phase to the above-mentioned reference phase in the reproduction image is “π/2”.

Then, the other phase modulation amount provided in the phase modulation segment unit is “3π/2” which is different by π from “π/2”.

In this manner, as the phase modulator 11 applies the divisive phase modulation based on the phase modulation amount “π/2” or “3π/2” in the phase modulation segment unit, with respect to the reproduction image in this case, the light in-phase to the reproduction image is added at one part, and the reversed-phase light is added at the other part.

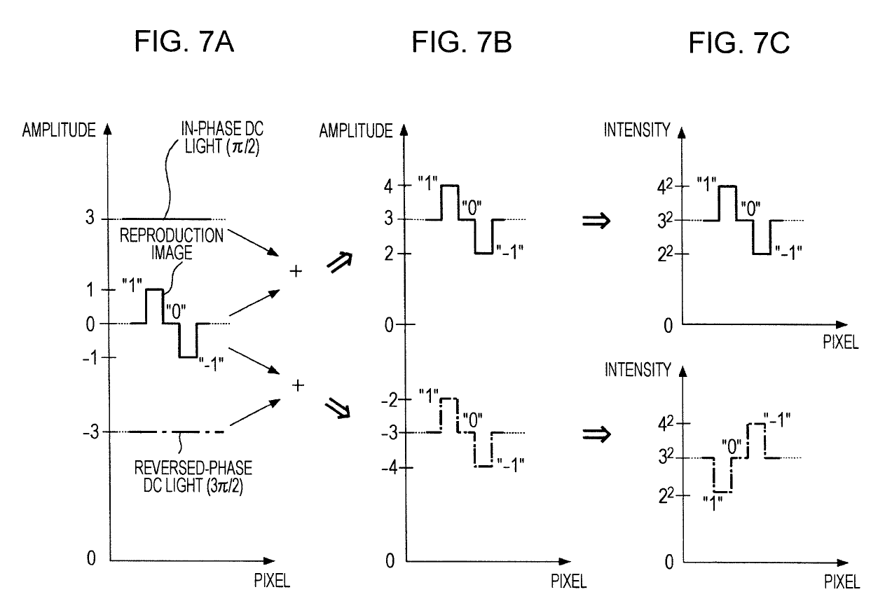

Herein, with respect to FIGS. 7A to 7C next, effects will be verified in a case where the in-phase component and the reversed-phase component are added to the reproduction image in the above-mentioned manner.

FIG. 7A shows a relation of an amplitude among the reproduction image having the amplitudes “1”, “0”, and “−1”, the in-phase DC light, and the reversed-phase DC light as a relation of an amplitude between the reproduction image and the DC light. Also, FIG. 7B shows an amplitude of a component in which the in-phase DC light is added to the reproduction image (the reproduction image+the in-phase DC light) and an amplitude of a component in which the reversed-phase DC light is added to the reproduction image (the reproduction image+the reversed-phase DC light) as the amplitude at the time of the image sensor imaging. FIG. 7C shows an intensity detection result by the image sensor 19 regarding the “reproduction image+in-phase DC light” and an intensity detection result by the image sensor 19 regarding the “reproduction image+reversed-phase DC light” as the image sensor detection intensity.

It should be noted that in the respective drawings, the case is exemplified in which the light intensity added to the reproduction image is set as “3”.

First, as shown in FIG. 7A, according to the intensity setting of the DC light in this case, the amplitude of the in-phase DC light is “3”, and the amplitude of the reversed-phase DC light is “−3”.

When the in-phase DC light of the amplitude “3” is added to the reproduction image, as shown in FIG. 7B, the amplitude in the pixel having the amplitude “1” in the reproduction image becomes “4”, the amplitude in the pixel of the amplitude “0” becomes “3”, and the amplitude in the pixel of the amplitude “−1” becomes “2”.

On the other hand, when the reversed-phase DC light of the amplitude “−3” is added to the reproduction image, the amplitude in the pixel having the amplitude “1” in the reproduction image becomes “−2”, the amplitude in the pixel of the amplitude “0” becomes “−3”, and the amplitude in the pixel of the amplitude “−1” becomes “−4”.

In this way, the reproduction image to which the DC light is added is detected by the image sensor 19. As described above as the Fourier transform hologram, in the image sensor 19, the light intensity is detected in which the wave-front amplitude of the incident light is squared and put into an absolute value.

Therefore, for the intensity detection result by the image sensor 19 regarding the “reproduction image+in-phase DC light”, as shown in the upper stage of FIG. 7C, the light intensity “4²” can be obtained for the pixel of the amplitude “1”, the light intensity “3²” can be obtained for the pixel of the amplitude “0”, the light intensity “2²”, can be obtained for as the pixel of the amplitude “−1”.

Also, for the intensity detection result by the image sensor 19 regarding the “reproduction image+reversed-phase DC light”, as shown the lower stage of FIG. 7C, the light intensity “2²” can be obtained for the pixel of the amplitude “1”, the light intensity “3²” can be obtained for the pixel of the amplitude “0”, and the light intensity “4²” can be obtained for the pixel of the amplitude “−1”.

Herein, according to the “coherent addition system” described above as the technology in the related art, the square root of the value detected by the image sensor is calculated, and the component of the added DC light is eliminated, so that the information of the recorded amplitude (“1”, “0”, or “−1”) is reconstructed.

According to the present embodiment too, the square root of the value detected by the image sensor 19 is similarly calculated, and a processing of eliminating the component of the added DC light is performed.

As a result of such a processing (which is referred to as linearization processing), for the component of the “reproduction image+in-phase DC light”, processing resultant values are obtained in which the pixel of the amplitude “1” is “4”, the pixel of the amplitude “0” is “3”, and the pixel of the amplitude “−1” is “2”.

Also, for the component of the “reproduction image+reversed-phase DC light”, processing resultant values are obtained in which the pixel of the amplitude “1” is “2”, the pixel of the amplitude “0” is “3”, and the pixel of the amplitude “−1” is “4”.

As will be understood also from this result, for the area to which the in-phase DC light is added, the processing resultant values similar to those in the “coherent addition system” described as the example in the related art are obtained.

In contrast to this, for the area to which the reversed-phase DC light is added, as compared with the case of the “coherent addition system” in the related art, processing resultant values are obtained in which the value of the pixel of the amplitude “1” and the value of the pixel of the amplitude “−1” are reversed.

It should be however noted that depending on the phase modulation recording, the three amplitude values of “1”, “0”, and “−1” are recorded, but the recorded data itself is one of the two values including “0” and “1”. That is, when the recorded data is reproduced, it suffices that at least the pixel of the amplitude “0” or the pixel of other amplitude can be identified by the recorded data.

Such a binary data identification method is similar to the case of adopting the “coherent addition system” in the related art. To be more specific, for this binary data identification up to now, a processing of identifying that the pixel where the value “0” is obtained as the processing resultant values of the linearization processing is the data “0” and the pixel where other processing resultant value is obtained is the data “1” is performed.

That is, as will be understood also from this, depending on the reproduction method based on the DC light addition system according to the present embodiment, for the value detected by the image sensor, by performing the reproduction processing similar to the related art example including the square root calculation, the elimination of the added DC light component, and the binary data identification is performed, the recorded binary data of “0” and “1” can be appropriately reproduced.

It should be noted that as a description is given for confirmation, for the “linear reading”, as shown in FIG. 7C, it is an important point that the intensity detection value of the pixel where the amplitude “1” is recorded (that is, the pixel of the phase 0) and the intensity detection value of the pixel where the amplitude “−1” is recorded (the pixel of the phase π) can be obtained as mutually different values. That is, at the time of the intensity detection in the image sensor, it is an important point that the phase information is not lost.

From the above-mentioned explanation, in a case where the phase modulation based on “0” or “π” is applied on the signal light and the reference light for the phase modulation recording, in order to appropriately reproduce the recorded binary data of “0” and “1”, it can be understood that the phase modulation amounts provided to the DC light in the phase modulator 11 in a divided manner are two types including “π/2” and “3π/2”.

Herein, for the phase modulation of the DC light, if a periodicity is given to the distribution of the segments where the phase modulation based on “π/2” is applied and the segments where the phase modulation based on “3π/2” is applied, it is difficult to effectively suppress the intensity concentration of the DC light on the Fourier plane. This is because, if the periodicity is given to the distribution in this manner (for example, in a case where the phases are periodically allocated to the respective segments like “π/2”→“3π/2”→“π/2”→“3π/2” . . . ), the concentration of the light intensity is generated at the position decided by the period on the Fourier plane.

In view of the above, the distribution of the segments respectively provided with the different phase modulation amounts is set to have a random nature. To be more specific, in this case, the number of the segments where the phase modulation based on “π/2” is applied and the number of the segments where the phase modulation based on “3π/2” is applied share equally, and for each segment, the phase modulation amount of “π/2” or “3π/2” is randomly allocated.

With this configuration, it is possible to effectively suppress the intensity concentration on the Fourier plane of the DC light.

Also, as will be understood from the above-mentioned phase modulation amount too, in the present example, the phase pattern based on two phases in which the phase difference is π with respect to the DC light (that is, in the reversed-phase relation) is provided. As the phase pattern based on two values in the reversed-phase relation in this manner is provided, with the similar principle to the case of the phase modulation recording, it is possible to effectively suppress the intensity concentration on the Fourier plane.

Configuration for Realizing the Reproduction Method According to the Embodiment

In order to reproduce the DC light addition system according to the embodiment described above, at the time of the reproduction, the modulation control unit 20 shown in FIG. 5 performs the following operation.

First, at the time of the reproduction, for the mapping processing of generating the reference light and the DC light, while the reference light area A1 is set as the pattern “0” or “1” similar to that at the time of the recording, the mapping unit 26 in the modulation control unit 20 further generates the data pattern in which the entire signal light area A2 is set as “1”, and other areas are all set as “0”. Then, this data pattern is supplied to the polarization control driver 27.

In accordance with the data pattern for all the pixels of the SLM 8 supplied from the mapping unit 26, the polarization control driver 27 performs the drive control on the respective pixels of the SLM 8. With this configuration, for the outgoing light from the polarization beam splitter 7 shown in FIG. 1 to the objective lens 17 side, the light which is the origin of the reference light provided with the same intensity pattern as that at the time of the recording and the light which is the origin of the coherent light with the uniform light intensity “1” over the entire area in the light beam area of the signal light.

It should be noted that as in the case of the “coherent addition system” in the related art, it is a condition that the intensity of the DC light when being added to the reproduction image is larger than the absolute value of the minimum value of the amplitude of the reproduction image.

According to the diffraction efficiency of the hologram described above (several % to lower than 1%), by performing the intensity modulation based on the light intensity “1” in the above-mentioned manner, such an intensity condition as to the DC light is sufficiently satisfied.

Also, in FIG. 5, at the time of the reproduction, furthermore, the phase modulation pattern generation unit 28 and the phase modulation driver 29 perform the following operation.

That is, the phase modulation pattern generation unit 28 generates the data pattern as the phase modulation pattern similar to that at the time of the recording for the reference light area A1 of the phase modulator 11.

Furthermore, for the signal light area A2, as the phase pattern in which the phase modulation segment previously described is set as the minimum modulation unit, a data pattern is generated in which all the pixels in the predetermined phase modulation segment are set as a value equivalent to the phase modulation amount “π/2” and all the pixels in the other phase modulation segments are set as a value equivalent to the phase modulation amount “3π/2”.

Then, data for the effective pixels of the phase modulator 11 is generated by combining these data patterns the data for all, and this data is supplied to the phase modulation driver 29.

Herein, as previously described in FIGS. 4A and 4B, the phase modulator 11 is configured to be able to modulate the phase of the respective pixels variably in accordance with the level of the drive voltage. To be more specific, in accordance with the level of the drive voltage, for the respective pixels, the phase can be variably modulated between “0” to “2π”.

While corresponding to this, the phase modulation driver 29 is configured to drive the respective pixels of the phase modulator 11 with the drive voltage at a level in accordance with the values “0” to “1” (for example, 0 to 255 in the case of 256 tones) from the phase modulation pattern generation unit 28.

On the basis of this promise, the value that should be set by the phase modulation pattern generation unit 28 when the phase modulation based on the phase modulation amount “π/2” is performed becomes “¼” (63 in the case of 256 tones) in the above-mentioned range between “0” to “1”. Similarly, the value that should be set for performing the phase modulation based on the phase modulation amount “3π/2” becomes “¾” (191).

Herein, as also described above, the phase pattern provided to the DC light desirably has the random nature. For this reason, the phase modulation pattern generation unit 28 sets the number of the segments where the phase modulation based on “π/2” is applied and the number of the segments where the phase modulation based on “3π/2” is applied half each and also randomly allocates “π/2” and “3π/2” for each segment, so that the value to allocated to the respective pixels in the respective segments (that is, “¼” or “¾”) is set.

Through the above-mentioned operation by the phase modulation pattern generation unit 28 and the phase modulation driver 29 at the time of the reproduction, the reference light provided with the same phase pattern as that at the time of the recording and the DC light provided with the random phase patterns based on “π/2” and “3π/2” while the phase modulation segment is set as the minimum modulation unit are output from the phase modulator 11.

As will be understood from the previous description, the hologram recording medium HM is irradiated with the reference light and the DC light thus generated via the objective lens 17, and accordingly, in the image sensor 19 shown in FIG. 1, the intensity detection is performed on the reproduction image and the component to which the DC light is added.

In the recording reproduction apparatus shown in FIG. 1, on the basis of the intensity detection result (image signal) thus obtained by the image sensor 19, the data reproduction unit 21 performs the reproduction of the recording data.

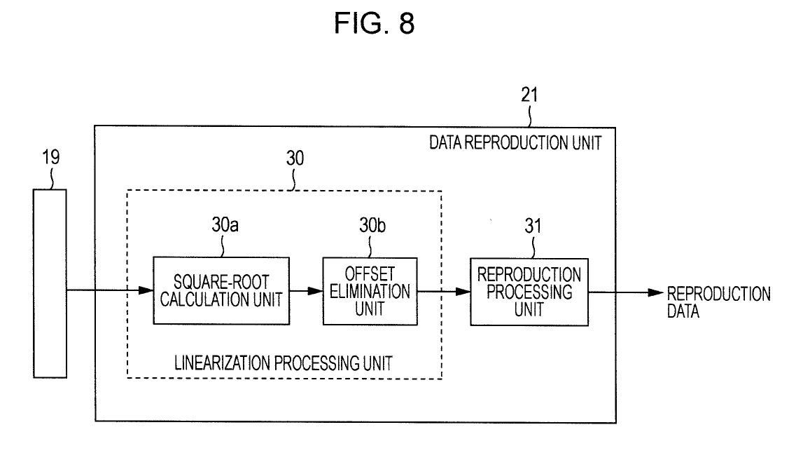

FIG. 8 shows an internal configuration of the data reproduction unit 21. It should be noted that FIG. 8 also shows the image sensor 19.

As shown in the drawing, the data reproduction unit 21 is provided with a linearization processing unit 30 and a reproduction processing unit 31.

The linearization processing unit 30 inputs the image signal serving as the detection result of the reproduction image+the DC light obtained by the image sensor 19 and performs a processing for the linear reading.

The linearization processing unit 30 in this time is provided with a square-root calculation unit 30a and an offset elimination unit 30b as shown in the drawing.

The square-root calculation unit 30a calculates a square root of the respective values constituting the image signals obtained by the image sensor 19 and supplies the result to the offset elimination unit 30b.

It should be noted that as a description is given for confirmation, depending on the image sensor 19, the detected intensity of the light is represented, for example, by an amplitude value based on a predetermined gray scale such as 256 tones. The square-root calculation unit 30a performs the square root calculation for the amplitude value of the respective pixels of the above-mentioned image sensor 19.

Also, the offset elimination unit 30b performs the processing for eliminating the component of the DC light (that is, the offset component with respect to the detection target reproduction image) from the value of the square root obtained by the square-root calculation unit 30a. To be more specific, the offset elimination unit 30b in this case performs the processing for respectively subtracting the value in accordance with the addition amount of the DC light from the value of the square root of the amplitude value of the respective pixels obtained by the square-root calculation unit 30a.

Herein, as a description is given for confirmation, the addition amount of the DC light refers to the intensity of the DC light added to the reproduction image. That is, in the previous example of FIGS. 7A to 7C, the addition amount of the DC light is |3|.

It should be noted that for the elimination of the offset component serving as the DC light herein, the method of subtracting the value of the addition amount of the DC light from the square root calculation resultant value is exemplified. However, instead of explicitly performing the subtraction processing in the above-mentioned manner, for example, it is possible to perform the elimination of the addition of the DC light by other methods. For example, the filter processing of eliminating the DC component is applied on the image signal as the square root calculation result obtained by the square-root calculation unit 30a.

Herein, as will be understood from the previous description, the linearization processing (the square root calculation/the offset elimination) is performed on the detection result of the DC light+the reproduction image, and it is therefore possible to obtain the linear read signal which appropriately represents the phase information recorded on the hologram recording medium HM by the phase modulation recording.

The linear read signal obtained by the linearization processing of the linearization processing unit 30 is supplied to the reproduction processing unit 31.

On the basis of the image signal serving as the linear read signal, the reproduction processing unit 31 reproduces the recording data. That is, the reproduction data is obtained.

To be more specific, the reproduction processing unit 31 performs an equalizing processing for suppressing an inter-symbol interference (inter-pixel interference) on the image signal serving as the linear read signal. Also, by setting the image signal after this equalizing processing as the target, a resampling processing for obtaining a value of the SLM 8 in the pixel unit included in the image signal is performed (value of the data pixel). Furthermore, the data identification processing between “0” and “1” on the basis of the value of the respective data pixels obtained through the resampling processing, the previously described encoding processing of the recording modulation sign by the encoding unit 25, and the like are performed to reproduce the recording data.

Herein, as previously described, the information on the amplitude recorded on the hologram recording medium HM while the phase modulation recording is performed is the three values of “1”, “0”, and “−1”. Among them, “1” and “−1” are both recorded as the data “1”, and therefore, at the time of the reproduction, the amplitude information of both “1” and “−1” is recognized as the data “1”. That is, for the data identification processing by the reproduction processing unit 31, the image signal after the linearization processing (the image signal after the resampling processing in this case), the data pixel of the amplitude value “0” (in the example of FIGS. 7A to 7C, the pixel of “3²”) is identified as the data “0”, and the data pixel of the other amplitude value (in the example of FIGS. 7A to 7C, “2²” or “4²”) is identified as the data “1”.

Simulation Result

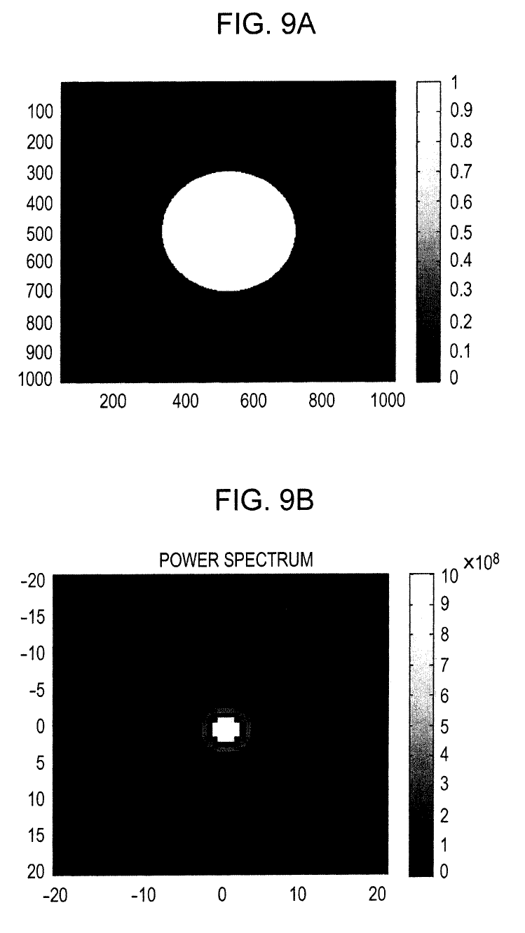

FIGS. 9A and 9B, 10A and 10B, and 11A and 11B show simulation results for verifying the effectiveness of the above-mentioned DC light addition system according to the embodiment.

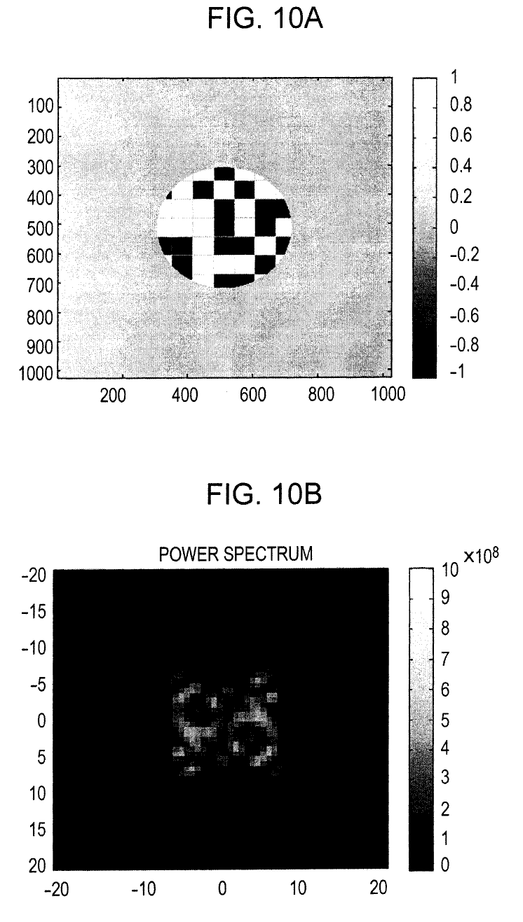

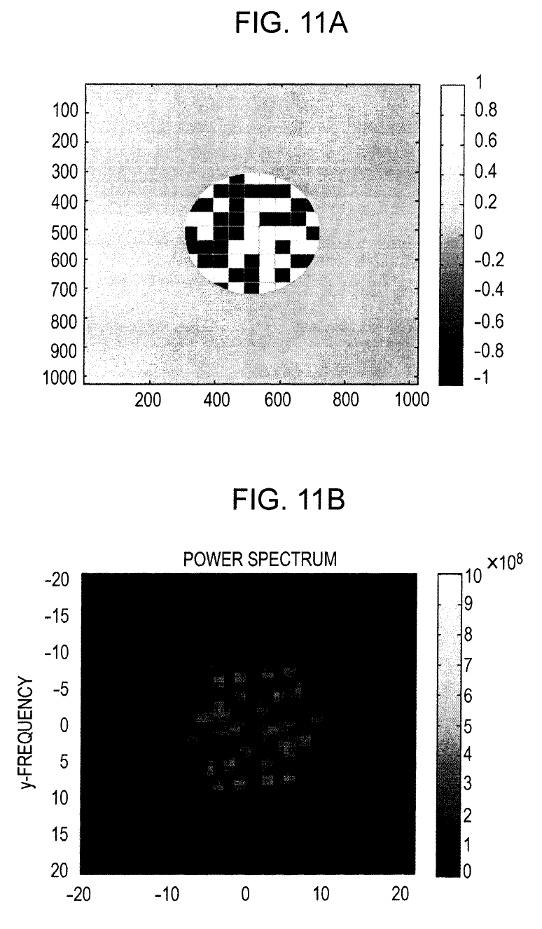

FIGS. 10A and 10B show the simulation results in a case where the sizes of the phase modulation segments are set as 64×64 pixels previously exemplified, and FIGS. 11A and 11B show the simulation results in a case where the sizes of the phase modulation segments are set as 48×48 pixels. FIGS. 10A and 11A show a phase modulation example of the DC light in the form of representing the amplitude value by way of the color density similarly as in FIG. 6, and FIGS. 10B and 11B show a result of the calculation through the simulation of the intensity distribution of the DC light on the Fourier plane shown in FIGS. 10A and 11A.

Also, for comparison, FIGS. 9A and 9B show the simulation results of the irradiation of the DC light on which the uniform modulation is applied in the related art example. FIG. 9A shows an amplitude pattern (phase modulation example) of the DC light, and FIG. 9B shows a calculation result of the intensity distribution on the Fourier plane.

The intensity distribution in FIGS. 9A, 10A, and 11A represents the strength and weakness of the light intensity by way of the color density, and the light intensity becomes stronger from black→white.

It should be noted that the premise for obtaining the calculation results shown in FIGS. 9A and 9B, 10A and 10B, and 11A and 11B is that a target pattern is arranged at the center of a two-dimensional matrix of 1024×1024 and this is set as the calculation target while taking into account a calculation of a two-dimensional FFT (fast Fourier transform) performed on a circular pattern having a diameter of 412 pixels. From the FFT calculation result of this pattern, a power spectrum is obtained to be set as the calculation result of the intensity distribution on the Fourier plane.

First, by comparing the results of FIGS. 10A, 10B, 11A, and 11B with the results of FIGS. 9A and 9B, it can be understood that the intensity concentration of the DC light on the Fourier plane is effectively suppressed as the DC light addition system according to the embodiment is adopted.

Also, by contrasting FIGS. 10A and 10B with FIGS. 11A and 11B, as the size of the phase modulation segment is reduced to increase the area division numbers, it can be understood that the intensity concentration of the DC light on the Fourier plane can be more effectively suppressed.

Also, for the respective DC lights of FIGS. 9A and 9B, 10A and 10B, and 11A and 11B, the maximum peak value on the Fourier plane is calculated. The results are as follows.
Maximum peak value on the Fourier plane

The DC light pattern of FIGS. 9A and 9B=1.78×10¹⁰ (arbitrary unit)

The DC light pattern of FIGS. 10A and 10B (64×64)=5.74×10⁸ (arbitrary unit)

The DC light pattern of FIGS. 11A and 11B (48×48)=3.93×10⁸ (arbitrary unit)

Also, the calculation of the DC peak suppression ratio in the case of FIGS. 10A, 10B, 11A, and 11B compared with the related art example of FIGS. 9A and 9B is performed.
DC peak suppression ratio compared with the related art example of FIGS. 9A and 9B

The DC light pattern of FIGS. 10A and 10B (64×64)=14.9 [dB] (suppressed to about 1/31)

The DC light pattern of FIGS. 11A and 11B (48×48)=16.6 [dB] (suppressed to about 1/45)

From these calculation results too, it can be understood that the intensity concentration of the DC light on the Fourier plane can be effectively suppressed by the divisive phase modulation according to the embodiment, and also with the reduction in the size of the phase modulation segment, the intensity concentration of the DC light can be more effectively suppressed.

Effects of the Embodiment

In the above-mentioned way, according to the present embodiment, the phase modulation based on the different phase modulation amounts is applied on the DC light in a dividing manner, so that the intensity concentration on the Fourier plane is prevented when the hologram recording medium HM is irradiated with the DC light. Then, as the intensity concentration on the Fourier plane of the DC light is thus prevented, the destruction of the data recorded on the hologram recording medium HM is prevented.

At this time, while corresponding to the phase modulation recording based on the two values of “0” and “π” (corresponding to the reference phase of the recording image becoming “0”), the phase modulation amounts provided in a dividing manner are set as the two values of “π/2” and “3π/2”, and the reproduction signal processing similar to that in the case of the “coherent addition system” in the related art is performed, so that the recorded binary data of “0” and “1” an be appropriately reproduced.

Also, in the above-mentioned manner, if the intensity concentration on the Fourier plane of the DC light is prevented, the gap layer is not inserted between the recording film and the reflection film of the hologram recording medium without problems unlike the method previously proposed by the applicant of the present invention. As a result, the deterioration of the recording reproduction characteristics accompanied by the insertion of the gap layer can be prevented.

### 3. Modified Example

The embodiment of the present invention has been described in the above, but the present invention should not be limited to the above-mentioned specific examples.

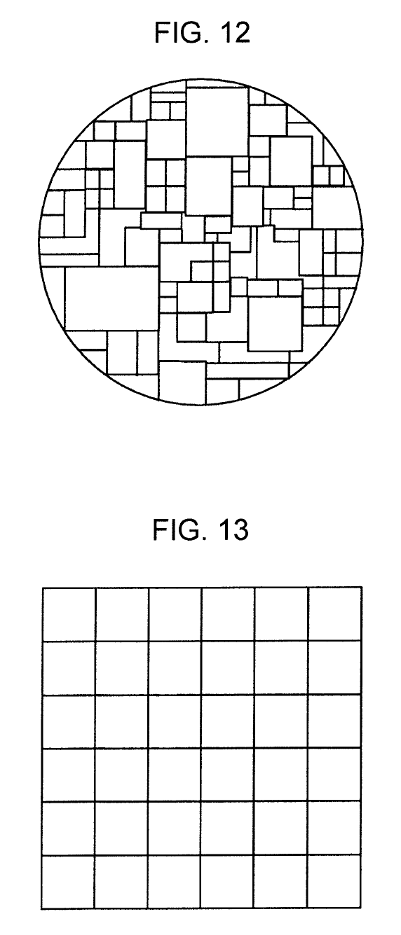

For example, in the description provided thus far, the case has been exemplified in which the area division of the phase modulation segment is performed in a lattice pattern and the sizes of the respective segments are set uniform, but for example, instead of the area division in a lattice pattern, as shown in FIG. 12, the sizes of the phase modulation segments can also be set nonuniform (that is, plural types of segments having different sizes are set).

By setting the sizes of the phase modulation segments nonuniform in this way, the suppression effect for the intensity concentration of the DC light on the Fourier plane can be increased as compared with the case of setting the uniform size.

Also, as shown in FIG. 12, the shape of the phase modulation segment is not limited to square, but other shapes can also be adopted.

Also, in the description provided thus far, the case has been exemplified in which when the phase modulation is applied on the DC light in a dividing manner, and the phase modulation is applied while the area formed by a predetermined number of pixels serving as the phase modulation segment is set as the minimum modulation unit. However, instead of providing such a phase modulation segment, the divisive phase modulation can also be applied while one pixel is set as the minimum modulation unit.

As previously described, when the size of the minimum modulation unit is smaller, the suppression effect for the intensity concentration on the Fourier plane is accordingly larger. Thus, with the configuration of performing the divisive phase modulation in units of pixel in this manner, the suppression effect for the intensity concentration can be maximized.

Also, the content of the reproduction signal processing with respect to the read signal (the image detected by the image sensor) obtained through the DC light addition according to the embodiment of the present invention is not limited to the previously exemplified one.

For example, the case is supposed in the previous description in which the binary data recording of “0” and “1” is performed, and the data identification method is adopted in which the pixel whose processing resultant value of the linearization processing is “0” is identified as the data “0”, and the pixel whose processing resultant value is other than “0” is identified as the data “1”. However, for the data, it is also possible to record the three values of “1”, “0”, and “−1”. In that case, the data identification method is changed.

In a case where such a three-value recording is performed, of course the identifications for “1” and “−1” are also performed. It should be however noted herein that in a case where the divisive phase modulation of the DC light is performed, among the phase modulation segments where the mutually different phase modulations are applied, the detection results of the amplitudes “1” and “−1” are reversed (see FIG. 7C). That is, in this case, in order to appropriately identify the data “1” and “−1”, the phase modulation segment where the phase modulation based on “π/2” is applied and the phase modulation segment where the phase modulation based on “3π/2” is applied, the mutually different date identifications are to be performed.

To be more specific, in the phase modulation segment of the phase modulation amount “π/2” (the phase modulation segment where the phase modulation is performed for setting in-phase to the reference phase of the reproduction image), the resultant value of the linearization processing for the data “1” becomes “1” and the processing resultant value of the data “−1” becomes “−1”. Thus, for the data identification, the pixel having the processing resultant value of “0” is identified as the data “0”, the pixel having the processing resultant value of “1” is identified as the data “1”, and the pixel having the processing resultant value of “−1” is identified as the data “−1”. On the other hand, in the phase modulation segment based on the phase modulation amount “3π/2” (the phase modulation segment performing the phase modulation based on the phase modulation amounts different by π), the resultant value of the linearization processing for the data “1” becomes “−1”, and the processing resultant value of the data “−1” becomes “1” reversely. Thus, while it is supposed that the identification for the data “0” is similar to the above, the pixel having the processing resultant value “−1” is identified as the data “1”, and the pixel having the processing resultant value “1” is identified as the data “−1”.

In this manner, when the data reproduction is appropriately performed while corresponding to the case of the three-value recording, the identifications for the data “1” and “−1” are set different for each segment in accordance with the phase modulation amounts.

Herein, in a case where the mutually different signal processings are performed in the phase modulation segment unit, for example, in a case where the different data identification processings are performed in the phase modulation segment unit, a border line between the phase modulation segments is provided. That is, border pixels having the light intensity=“0” are provided between the respective phase modulation segments (for example, for about two pixels wide).

When the border line is provided, it is easier to extract the respective phase modulation segments from the image detected by the image sensor, which is preferably.

To be more specific, in a case where the above-mentioned border line is provided, the mapping unit 26 in the modulation control unit 20 may allocate “0” to the respective pixels relevant to the border line in the signal light area A2 at the time of the recording.

Also, in a case where the signal processing in units of segment is to be performed as described above, the signal processing for the respective segments is conceived to be performed in parallel. In this manner, in a case where the parallel processing in units of segment is performed, the phase modulation segment is desirably divided and formed into a lattice pattern as exemplified according to the embodiment. That is, when the sizes of the respective segments are uniform through the lattice pattern division, the processing speed for each segment can be set uniform.

Also, in the description provided thus far, the case has been exemplified in which for the prevention of the data destruction, the suppression of the intensity concentration is realized through the divisive phase modulation of the DC light, but for example, if a unit configured to suppress the intensity of the light in the signal light area at the time of the reproduction is separately provided, it is possible to realize the prevention of the data destruction more steadily.

To be more specific, a configuration is exemplified in which a partial dimmer element formed of a dimmer material (for example, a metallic film or the like) is inserted into the optical path only in the area corresponding to the signal light area only at the time of the reproduction. Alternatively, a configuration may also be adopted that instead of the ½ wavelength plate 6 in FIG. 1, a partial polarization direction control element in which a ½ wavelength plate is formed only in the area corresponding to the signal light area is inserted, and a rotation drive is performed on this partial polarization direction control element with the actions of the ½ wavelength plate and the polarization beam splitter 7 only at the time of the reproduction so that the amount of the incident light into the signal light area A2 on the SLM 8 is attenuated.

Also, in the description provided thus far, the case has been exemplified in which the intensity modulation unit which performs the intensity modulation for generating the signal light and the reference light is represented by the combination of the polarization direction control type spatial light modulator (the SLM 8) and the polarization beam splitter, but instead of this, the spatial light modulator functioning as the intensity modulator capable of performing the intensity modulation by itself can also be used without combining with the polarization beam splitter such as, for example, a DMD (Digital Micro mirror Device: registered trademark).

Also, for the spatial light modulator, instead of the reflective type, the transmissive type (for example, the transmissive type liquid crystal panel or the like) may also be used.

Also, in the description provided thus far, the configuration of the recording reproduction apparatus in the case of corresponding to the reflective type hologram recording medium HM has been exemplified, but the configuration of the recording reproduction apparatus corresponding to the transmissive type hologram recording medium provided with no reflection film can also be adopted.

In the case of the transmissive type hologram recording medium, in accordance with the irradiation of the reference light at the time of the reproduction, the reproduction image is output to the opposite side so as to pass through the hologram recording medium.

From this point, for the recording reproduction apparatus in this case, another objective lens is separately provided at a position on the opposite side of the hologram recording medium as viewed from the light source side, and the reproduction image and the DC light enter the objective lens. Then, the optical system is configured so that the reproduction image and the DC light obtained via this objective lens are guided to the image sensor 19.

Also, in the description provided thus far, the case has been exemplified in which the substantially annular reference light area A1 is provided on the outer side of the substantially circular signal light area A2, but the shapes of the signal light area and the reference light area are not limited to these substantially circular and substantially annular shapes. Also, the reference light area can be arranged in the inner side, and the signal light area can be arranged in the outer side.

Herein, in a case where the shape of the signal light area is set to be rectangular, for example, as shown in FIG. 13, the sizes of the phase modulation segments can be set equal to one another in the entire signal light area.

It should be however noted that when the shape is set to be substantially circular too, for example, in a case where the size of the phase modulation segment is set as a relatively small size such as 4×4 pixels, the segment sizes can be set equal to one another in the entire signal light area.

Also, in the description provided thus far, the case has been exemplified in which the reproduction apparatus according to the embodiment of the present invention is applied to the recording reproduction apparatus capable of performing both the recording and the reproduction, but a reproduction apparatus according to an embodiment of the present invention can also of course be configured as a reproduction-only apparatus without a recording function.

The present application contains subject matter related to that disclosed in Japanese Priority Patent Application JP 2008-231361 filed in the Japan Patent Office on Sep. 9, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A reproduction apparatus comprising:
a light source configured to perform a light irradiation on a hologram recording medium on which data is recorded by way of interference fringes resulting from a signal light and a reference light;
an intensity modulation unit provided with a spatial light modulator arranged to apply a spatial light modulation on an incident light in units of pixel while setting a signal light area serving as a generation area for the signal light and a reference light area serving as a generation area for the reference light and configured to perform a spatial light intensity modulation on the incident light;
a phase modulator configured to apply a spatial light phase modulation on the incident light in units of pixel while setting the signal light area and the reference light area;
an optical system configured to guide a light emitted from the light source to the hologram recording medium via the intensity modulation unit, the phase modulator, and an objective lens; and
a modulation control unit configured to generate the reference light by performing a drive control on respective pixels in the reference light areas of the spatial light modulator and the phase modulator and also generate a DC light to be added to a reproduction image by performing a drive control in the signal light area of the spatial light modulator to apply a spatial light intensity modulation at a same modulation amount in all pixels and performing a drive control in the signal light area of the phase modulator while setting one part of phase modulation amounts as a phase modulation amount for setting a same phase as a reference phase in the reproduction image obtained from the hologram recording medium in accordance with an irradiation of the reference light and setting the other part of the phase modulation amounts as a phase modulation amount different by π with respect to the one part of the phase modulation amounts.

2. The reproduction apparatus according to claim 1,
wherein the modulation control unit performs the drive control in a manner that the phase modulation in the signal light area of the phase modulator is performed while a predetermined segment unit is defined as a minimum modulation unit.

3. The reproduction apparatus according to claim 2,
wherein the segment is set by dividing the signal light area into a lattice pattern.

4. The reproduction apparatus according to claim 2,
wherein plural types of segments having different sizes are set as the segment.

5. The reproduction apparatus according to claim 2,
wherein the modulation control unit performs the drive control on the phase modulator in a manner that the phase modulation based on π/2 or 3π/2 is performed while the segment is defined as a minimum modulation unit.

6. The reproduction apparatus according to claim 5,
wherein the reproduction apparatus has also a recording function for the hologram recording medium, and
wherein at the time of the recording, for the drive control on the spatial light modulator, the modulation control unit performs the drive control on the respective pixels in a manner that light intensity patterns “0” and “1” in accordance with recording data are provided to the incident light in the signal light area and predetermined light intensity patterns “0” and “1” are provided to the incident light in the reference light area, and also for the drive control on the phase modulator, the modulation control unit performs the drive control on the respective pixels in a manner that the phase modulation based on 0 or π is applied on the incident lights in the signal light area and the reference light area in units of pixel, and
at the time of the reproduction, for the drive control on the spatial light modulator, the modulation control unit performs the drive control on the respective pixels in a manner that the spatial light intensity modulation at a predetermined intensity amount is applied on an entirety of the incident light in the signal light area and the same light intensity pattern as the light intensity pattern at the time of the recording is provided to the incident light in the reference light area, and also for the drive control on the phase modulator, the modulation control unit performs the drive control on the respective pixels in a manner that the spatial light phase modulation based on the same phase modulation pattern as the phase modulation pattern at the time of the recording is applied on the incident light in the reference light area and the phase modulation based on π/2 or 3π/2 is applied on the incident light in the signal light area while the segment is defined as the minimum modulation unit.

7. The reproduction apparatus according to claim 5, further comprising:
an image sensor configured to obtain an image signal by receiving a light of the incident image in units of pixel,
wherein the optical system is configured to guide the reproduction image obtained in accordance with the irradiation of the reference light from the hologram recording medium and the DC light via the hologram recording medium to the image sensor, and
wherein the optical system further includes
a square root calculation unit configured to input an image signal obtained as a result of the light reception of the image sensor to calculate a square root of the respective values constituting the image signal,
an offset elimination unit configured to eliminate a component of the DC light from the image signal as a result of the square root calculation by the square root calculation unit, and
a reproduction processing unit configured to perform a reproduction processing for reproducing the recorded data on the basis of an image signal after an elimination processing by the offset elimination unit.

8. The reproduction apparatus according to claim 7,
wherein the reproduction processing unit reproduces the data by performing data identification for amplitude values in units of pixel of the spatial light modulator in the image signal in which a pixel having the amplitude value “0” is identified as data “0” and a pixel having an amplitude value other than the amplitude value “0” is identified as data “1”.

9. The reproduction apparatus according to claim 2,
wherein the reproduction apparatus has also a recording function for the hologram recording medium, and
wherein for the drive control on the spatial light modulator, the modulation control unit performs the drive control is a manner that the light intensity of the respective pixels serving as a border area of the segment in the signal light area becomes “0”.

10. The reproduction apparatus according to claim 1,
wherein the intensity modulation unit includes
a spatial light modulator configured by including a ferroelectric liquid crystal element arranged to change a polarization direction of the incident light in units of pixel, and
a polarization beam splitter inserted at a position the light via the spatial light modulator enters.

11. The reproduction apparatus according to claim 1,
wherein the intensity modulation unit is composed of a spatial light modulator functioning as an intensity modulator arranged to be able to perform a spatial light modulation on the incident light in units of pixel.

12. A reproduction method for a reproduction apparatus including a light source configured to perform a light irradiation on a hologram recording medium on which data is recorded by way of interference fringes resulting from a signal light and a reference light, an intensity modulation unit provided with a spatial light modulator arranged to apply a spatial light modulation on an incident light in units of pixel while setting a signal light area serving as a generation area for the signal light and a reference light area serving as a generation area for the reference light and configured to perform a spatial light intensity modulation on the incident light, a phase modulator configured to apply a spatial light phase modulation on the incident light in units of pixel while setting the signal light area and the reference light area, and an optical system configured to guide a light emitted from the light source to the hologram recording medium via the intensity modulation unit, the phase modulator, and an objective lens, the method comprising the steps of:
generating the reference light by performing a drive control on respective pixels in the reference light areas of the spatial light modulator and the phase modulator; and
generating a DC light to be added to a reproduction image by performing a drive control in the signal light area of the spatial light modulator to apply a spatial light intensity modulation at a same modulation amount in all pixels and performing a drive control in the signal light area of the phase modulator while setting one part of phase modulation amounts as a phase modulation amount for setting a same phase as a reference phase in the reproduction image obtained from the hologram recording medium in accordance with an irradiation of the reference light and setting the other part of the phase modulation amounts as a phase modulation amount different by π with respect to the one part of the phase modulation amounts for the drive controls in the respective pixels in the signal light areas of the spatial light modulator and the phase modulator.
